(19) United States
(12) Patent Application Publication
(10) Pub. No.: US 2002/0082868 A1
(43) Pub. Date: Jun. 27, 2002

(54) Systems, methods and computer program products for creating and maintaining electronic medical records

(76) Inventors: Walter J. Pories, Macclesfield, NC (US); Mohammad Tabrizi, Greenville, NC (US)

Correspondence Address: MYERS BIGEL SIBLEY & SAJOVEC, PO BOX 37428, RALEIGH, NC, 27627, US

(21) Appl. No.: 09/749,330

(22) Filed: Dec. 27, 2000

(51) Int. Cl. G06F 17/60

(52) U.S. Cl. 705/3

(57) ABSTRACT

Systems, methods, and computer program products that generate electronic clinical medical records from patient encounters are provided. An illness for a particular patient is entered into a data processing system via an input device. Next, a defined retrievable clinical lexicon for that illness is displayed via the input device. The defined retrievable clinical lexicon comprises words and phrases associated with the illness. After the lexicon is displayed, a subset of words and phrases is selected from the lexicon for that patient encounter. A clinical medical record is then generated from the selected subset of words and phrases. A clinical medical record may be stored with like records for that patient and other patients, and associated with demographic records, fiscal records, drug administration records and the like for the patient. The collection of clinical records so created may be readily searched due to the enhanced uniformity of the records so created.

A portion of the disclosure of this patent document contains material to which a claim of copyright protection is made. The copyright owner has no objection to the facsimile reproduction by anyone of the patent document or the patent disclosure, as it appears in the Patent and Trademark Office patent file or records, but reserves all other rights whatsoever.

### FIELD OF THE INVENTION

The present invention concerns methods, systems, and computer program products for creating and maintaining medical and veterinary records, particularly medical and veterinary records containing clinical information.

### BACKGROUND OF THE INVENTION

In the United States, about 1.2 trillion dollars presently is spent every year on health care. Fifteen percent of this, or 180 billion dollars, is spent on medical records. Yet, the current state of the art for medical records remains the paper file. Electronic records have been of some success in providing demographic data and fiscal information, but they may not provide an effective means to communicate clinical information. Hence electronic records may be considered only a partial success, at best.

Demographic information includes patient name, age, sex, race, address, employer, policy number, appointment information and the like. Current computer systems can handle such information well. Likewise, fiscal data such as coding, billing, collections, appeals, and even lab data and prescriptions are well handled by a computer. However, the most critical piece of the medical record is clinical information such as symptoms, signs, side effects, complications, and outcomes such as performance, effectiveness and efficiency. Even in the most advanced medical centers, clinical data are entered by free text, hand-written, typed or dictated, which then becomes retrievable as text for an individual patient, but which may not be easily available for analysis for multiple patients or patient populations. For example, if one were to search a medical record database with a wordfinder for “infection”, both a record stating “the patient had a severe wound infection” and a record stating “the patient shows no signs of infection” may be recovered. Accordingly, there remains a need for new ways to create medical records, particularly clinical records, that provide easily searchable and accessible information for multiple patient populations.

U.S. Pat. No. 5,832,450 to Myers et al. (assigned to Scott & White Memorial Hospital, Temple, Tex.) provides an electronic medical record system that employs a text database. FIG. 2b therein shows a medical record, including a “chief complaint”. The system maintains the “original free-text content generated from a provider-patient encounter.” (column 5, lines 56-57). As indicated in FIG. 3 and the text at column 6, there are “no constraints” on the body portion of the text, and it may be “identical to that which would be found in a corresponding paper record for the same encounter.” At column 7, it goes on to state that tapes dictated by the provider may be transcribed and inserted directly into an encounter record. Thus, no effort is made to control the clinical language used to create the medical record—indeed, it appears that every effort is made to avoid control of the clinical language.

U.S. Pat. No. 5,823,948 to Ross and Lynch (assigned to RLIS Inc. of San Antonio, Tex.) describes a medical records system that provides for, among other things, the automatic incorporation of dictated text, medical records summary generation in medical English text, pre-phrased text, and automatic generation of a medical record as a consequence of data entry. The system includes a language generation module (105) that builds sentences from stored medical facts, a prephrased text module (112) and a transcript module (113) for converting dictated text into a portion of the medical record. However, this reference does not appear to deal with the problem of non-standard language usage among different medical records, and does not suggest or disclose a way to create an easily searchable clinical medical record.

U.S. Pat. No. 5,974,389 to Clark et al. (assigned to Glaxo Wellcome) describes a medical record management system in which multiple different caregivers may have access to a given medical record, but which includes a set of rules that require access to a portion of the medical record to be terminated by one caregiver before that portion can be accessed by another caregiver. A way to create an easily searchable clinical medical record is neither suggested nor disclosed. U.S. Pat. No. 5,546,580 to Seliger et al. describes a system similar to that of Clark et al.

U.S. Pat. No. 5,812,983 to Kumagai describes a system for generating medical charts from therapeutic data and clinical data so that the data can be displayed with the same time scale. Kumagai appears to be primarily concerned with data presentation, and is not concerned with providing a means to create an easily searchable clinical record.

U.S. Pat. No. 6,006,191 to DiRienzo describes a system for the remote access and exchange of medical images. This reference does not appear to be concerned with the writing of a clinical record.

U.S. Pat. No. 5,924,074 to Evans (assigned to Azron Inc. of San Diego, Calif.) describes an electronic medical records system, but entry of data into the system as described at columns 5-7 does not appear to provide a way to create an easily searchable clinical record.

Accordingly, there remains a need for new ways to prepare and create clinical records that are reasonably uniform in nomenclature from patient to patient, and provide a way to easily search a database of multiple clinical records.

### SUMMARY OF THE INVENTION

In view of the above discussion, embodiments of the present invention provide systems, methods, and computer program products that can generate electronic clinical medical records from patient encounters. Retrieval, analysis, and reporting of clinical data, i.e., symptoms, signs, complications, and outcomes, of medical records created and maintained in accordance with embodiments of the present invention can be facilitated.

According to embodiments of the present invention, in response to receiving a “chief complaint” from a patient, a clinician (i.e., a physician, nurse, or other health care provider) enters a “present illness” for the patient into a data processing system via an input device, preferably via a handheld touch tablet device. In response to entry of the present illness, a defined retrievable clinical lexicon (DRCL) for the entire medical record, including the present illness, past history, review of systems, and physical examination is displayed serially and logically via the input device. The DRCL comprises words and phrases associated with the present illness. After the DRCL is displayed, these words and phrases may be selected by the clinician as he/she interviews/examines the patient during the encounter. According to embodiments of the present invention, DRCL entries can be qualified by severity with numerical scales and location by anatomic diagrams. A clinical medical record is then generated from the selected, retrievable words and phrases.

The medical record may be stored with like records for that patient and other patients, and associated with demographic records, fiscal records, drug administration records and the like for the patient. The collection of clinical records so created may be readily searched due to the enhanced uniformity of the records so created.

According to embodiments of the present invention, words and phrases may be added to and/or deleted from a DRCL as required by clinicians. In addition, words and phrases not used within a certain time period may be dropped from a DRCL automatically. As such, DRCLs can be easily modified over time.

According to embodiments of the present invention, a DRCL may be displayed to a clinician (and medical records created and/or revised as described above) as a result of entry of any type of patient information. For example, any type of illness (past, present, or future) may be entered by a clinician and a DRCL associated therewith may be presented to the clinician. As another example, information entered by a clinician that is associated with illnesses of a patient's family members may trigger the presentation of one or more DRCLs from which words and phrases may be selected for creating and/or modifying the patient's medical record(s). As another example, information entered by a clinician can generate a genetic family tree that provides an overview of familial diseases and that prompts the clinician for appropriate action.

Systems, methods, and computer program products that generate and maintain electronic clinical medical records according to embodiments of the present invention manage clinical data by presenting providers with “the right words in the right place at the right time” and preferably on a touch tablet with rapid entry. The pre-selection and identification of words and phrases can assure that each word and phrase is clearly defined and has only one meaning. Because each of the words is already in the computer's system, the entry can be recorded with accuracy and entered for immediate statistical and epidemiologic manipulation.

### BRIEF DESCRIPTION OF THE DRAWINGS

FIG. 1A is a schematic illustration of a system for generating electronic medical records according to embodiments of the present invention.

FIG. 1B is a block diagram of a data processing system for use in implementing the Sequoiah server of FIG. 1A, according to embodiments of the present invention.

FIG. 2 illustrates a user interface associated with a filter for extracting relevant words and phrases from various data sources and placing them into appropriate lexicons, according to embodiments of the present invention.

FIGS. 3-6 schematically illustrate a patient encounter wherein a clinician generates a medical record in accordance with embodiments of the present invention. FIG. 3 illustrates a portion of a patient encounter wherein an identification of a present illness (“abdominal pain”) of a patient is entered into a data processing system via an input device. FIG. 4 illustrates a defined retrievable clinical lexicon displayed in response to an identification of a present illness. FIG. 5 illustrates words and/or phrases selected from the displayed defined retrievable clinical lexicon by a clinician during the patient encounter. FIG. 6 illustrates a clinical medical record generated from the selected words and phrases of FIG. 5. Each of these words is retrievable.

FIGS. 7-8 are flow charts of systems, methods and/or computer program products for generating and searching electronic clinical medical records, according to embodiments of the present invention.

FIGS. 9A-9B illustrate exemplary registration user interfaces wherein various data associated with a patient (e.g., personal information, billing information, referring physician information, and insurance information) can be entered into a data processing system, according to embodiments of the present invention.

FIG. 10 illustrates an exemplary user interface that can be presented to a clinician at the beginning of a patient encounter and within which a patient's chief complaint, among other information, can be entered.

FIG. 11 illustrates an exemplary user interface for use by a clinician in selecting a present illness and, subsequently, a lexicon associated with the present illness for use in generating a medical record for the patient, according to embodiments of the present invention.

FIGS. 12-15 illustrate exemplary user interfaces for use by a clinician in progressively building a patient medical record during a patient encounter, according to embodiments of the present invention.

FIGS. 16-18 illustrate various exemplary user interfaces that facilitate the entry of various types of data by a clinician during a patient encounter, according to embodiments of the present invention. FIG. 16 illustrates an exemplary user interface that can allow a clinician to quickly enter various information about a patient during a physical examination of the patient. FIG. 17 illustrates an exemplary user interface that displays a family (genomic) tree for a patient and wherein illnesses of members of the patient's genomic tree are identified and which can be included within a patient's medical records. FIG. 18 illustrates an exemplary user interface for use by a clinician in quickly entering various anatomical information about a patient during an encounter, according to embodiments of the present invention.

FIGS. 19-21 illustrate an electronic medical record for a patient generated during an encounter with a clinician in accordance with embodiments of the present invention.

FIGS. 22-23 illustrate various user interfaces for conducting statistical analyses using medical records created in accordance with embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

### Definitions

“Demographic data” as used herein includes, but is not limited to, one or more of age, race, gender, type of employment, location of employment, location of residence, social security number, marital status, level of education, or any other item of demographic data.

“Existing medical condition” as used herein refers to any type of medical condition, physical or behavioral, whether or not that medical condition has been the subject of a prior medical treatment, and whether or not that treatment has been completed or that condition has been considered “cured.” Examples of existing medical conditions include, but are not limited to, cancer (e.g., lung, liver, colon, breast, prostate, ovarian, etc.), heart disease (e.g., atherosclerosis), arthritis (rheumatoid arthritis and osteoarthritis), diabetes, asthma, tobacco smoking, alcohol consumption, obesity, etc., as well as injuries such as a broken bone, cuts and lacerations, internal injuries such as lacerated liver, or ruptured spleen, etc.

“Illness” as used herein refers to any illness of a patient, including past, present, or future illnesses.

“Interview” and “encounter” between patient and clinician include a verbal interview as well as physical examination. When a patient is non-human, verbal interview may be through the owner of the patient.

“Medical record” as used herein refers to one or more collections of various information about a patient including, but not limited to, demographic information, present illness information, past illness information, family illness information, social information, physical examination information, medical diagnoses, laboratory data, x-ray reports, special studies, prescriptions, medications, therapies, consultation reports, records from previous hospitalizations, and clinic visits.

“Patient” herein refers primarily to human patients, but also includes veterinary patients such as dogs, cats, cows, horses, etc.

“Present illness” as used herein refers to an initial illness, injury or complaint determined by a clinician for entry into a data processing system, wherein entry of an identification of the illness during a patient encounter or session initiates methods for generating an electronic clinical medical record, according to embodiments of the present invention. The term “present illness” differs from “chief complaint” in that the “present illness” is selected from a standard set of terms based upon the initial judgment of a clinician, while the “chief complaint” is recorded in the words of the patient. Thus the present illness may be an “existing medical condition.”

“Prior medical treatment” as used herein refers to any type of treatment previously administered to a patient, including surgical intervention (including implantation of a pacemaker, arrhythmia treatment device, etc.), prior or ongoing pharmaceutical treatment, behavior modification such as dietary change, smoking cessation, etc.

“Treatment data” as used herein includes, but is not limited to, dosage, experimental vs. control (i.e., active compound vs. placebo), route of administration, duration of therapy, or any other item of treatment data.

### Overview

In overview, embodiments of the present invention provide computer-based systems, methods and computer program products for creating and searching electronic medical records which can be readily implemented in a patient-clinician environment, without the need to disrupt an interview process with a particular patient.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, or in various other programming languages. Software embodiments of the present invention do not depend on implementation with a particular programming language. In addition, portions of the program code may execute entirely on one or more data processing systems.

The present invention is described below with reference to block diagrams and/or flowchart illustrations of methods, apparatus (systems) and computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

Prior to a patient encounter, a “chief complaint” may be entered into a system. For example, during registration prior to an encounter with a clinician, a patient may tell the person inputting registration information that his chief complaint is “I'm too fat”, in the words of the patient. When a patient-clinician encounter begins, the clinician will typically be presented with the chief complaint via a client device, and will begin to interview the patient. Based upon this interview, an illness (which may be a past illness, a present illness, or even a future potential illness) is selected by the clinician from a menu of available illnesses displayed within the client device and then entered into a data processing system.

In the illustrated embodiment, a clinician selects a present illness of the patient. However, it is understood that embodiments of the present invention allow a clinician to select any illness (past, present, or future) and any other type or category of information having a lexicon associated therewith from which words and/or phrases may be selected to create and/or modify patient medical records, as described in detail below.

Entry of the present illness then causes a defined retrievable clinical lexicon (DRCL) to be displayed within the client device. The DRCL preferably includes a list or set of words and phrases that describe symptoms (as well as other information) that are associated with the present illness that has been selected. Note that all of the words and phrases displayed by a particular DRCL need not be associated with any one particular disease which may cause the present illness.

The clinician may then proceed, by interviewing the patient, to select the words and phrases from among the DRCL list that are reported by the patient. When the selection process is completed, the system generates a written clinical record for that patient from among the words and phrases selected from the DRCL. Preferably, the written clinical record is then stored in searchable, electronic form with other clinical records from that patient, and other patients.

In a preferred embodiment, information is displayed and data is entered on a touch pad display. However, if the patient reports a symptom that does not appear in the DRCL, the clinician has the option of manually entering a word or phrase describing that symptom, thereby adding it to the DRCL for that particular present illness. On the other hand, if a particular word or phrase in the DRCL is not used a sufficient number of times with a particular present illness (e.g., after entry of the corresponding present illness 3 or 4 times during separate data entry sessions), then it may be dropped from the DRCL. Thus, the DRCL for a particular present illness can evolve over time as additional patients are screened.

Preferably, to avoid disruption of a clinician-patient interview session, the contents of a DRCL for a given present illness are displayed simultaneously so that the clinician may quickly select the desired words and phrases therefrom. This is in contrast to an expert system that might be used to diagnose a particular disease from a series of complaints and responses to questions, in which questions are posed and responses given in a sequential format.

Systems according to embodiments of the present invention can be implemented with other components or other medical software systems to provide for patient registration, prescription writing, incorporation of laboratory reports, setting appointments, statistical analysis, etc. As also discussed below, applications of the present invention include, but are not limited to, conducting clinical trials, conducting epidemiological studies, and health planning.

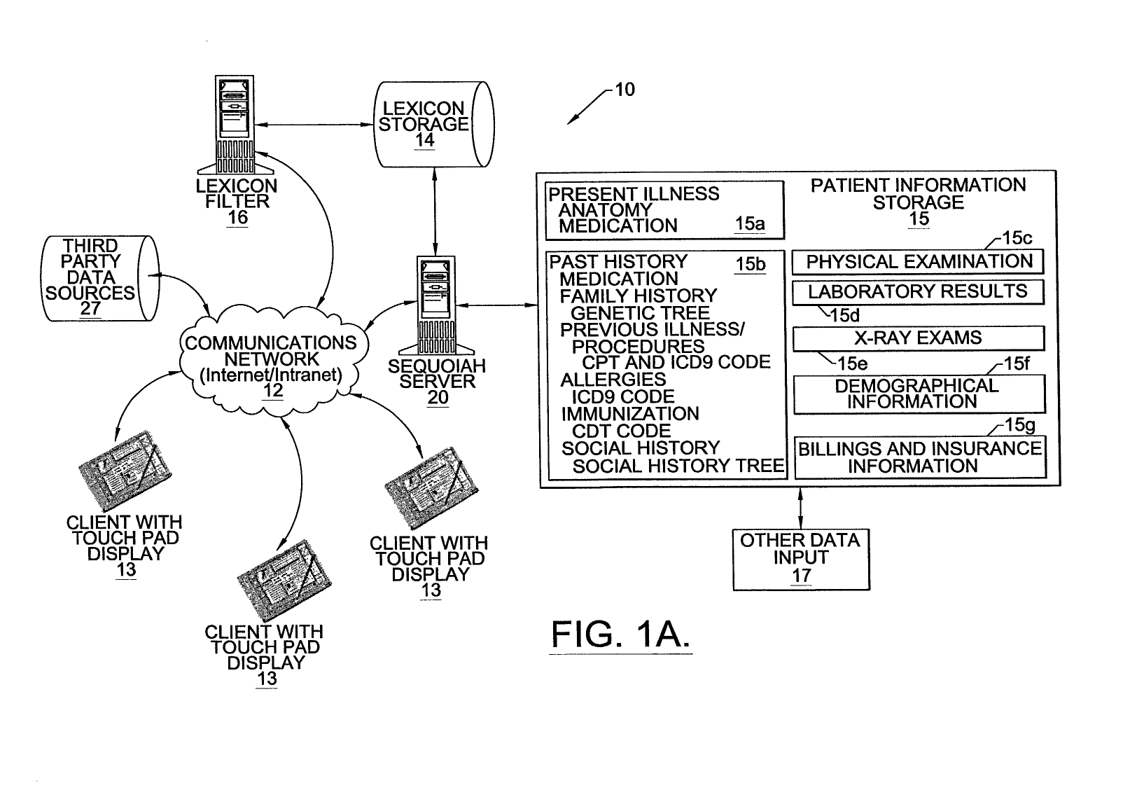

FIG. 1A illustrates an exemplary system 10 for generating electronic medical records according to embodiments of the present invention. The illustrated system 10 includes a server 20 (referred to as the Sequoiah server) that is connected to a communications network 12 (e.g., the Internet, an intranet, a cellular radiotelephone network, or satellite radiotelephone network, etc.). A plurality of client devices 13 are also connected to the communications network 12.

In the illustrated embodiment, the Sequoiah server 20 is in communication with lexicon storage 14 and patient information storage 15, each of which will be described below. The Sequoiah server 20 is configured to add, delete, and modify data within patient information storage 15 and lexicon storage 14, as will be described below. Moreover, the Sequoiah server 20 is configured to allow clinicians to quickly and accurately create electronic medical records via remote client devices 13.

A client device 13 may be connected to the Sequoiah server 20 by any suitable means, or may be a stand-alone device that is periodically “docked” to the Sequoiah server 20 for the delivery of data. Exemplary client devices 13 include, but are not limited to, personal computers, wireless communications devices, personal digital assistants (PDAs), hand-held computers, Internet-ready phones, and WebTVs. Client devices 13 according to embodiments of the present invention may be directly connected to the communications network 12 (e.g., “hard-wired”) or may communicate with the communications network 12 wirelessly.

A preferred client device 13 incorporates a touch-pad display. A touch-pad display is preferred because it facilitates data entry while allowing a clinician to maintain eye contact with patients. A preferred touch pad display is available from Fujitsu PC Corporation, 5200 Patrick Henry Drive, Santa Clara, Calif. 95054. However, various other touch pad devices may be utilized without limitation.

A preferred implementation of the present invention utilizes the Application Service Provider (ASP) model. As is understood by those of skill in the art, an ASP is an entity that offers individuals and enterprises access over the Internet (or other communications network) to applications and related services that would otherwise have to be located in local computers and/or devices. According to the illustrated embodiment of FIG. 1A, a clinician accesses the Sequoiah server 20 via a client device 13 for one or more applications for generating, modifying, deleting, and/or searching medical records. These applications may execute entirely on the Sequoiah server 20 (or other remote data processing system), or partly on the Sequoiah server 20 and partly on a client device 13.

However, it is understood that other implementations of the present invention may be utilized as well. The present invention is not limited to a particular implementation or to the illustrated embodiment. For example, applications for generating, modifying, deleting, and/or searching medical records may execute entirely on a client device 13.

During an encounter or session with a particular patient, a clinician may enter a description of a present illness into a client device 13, which causes a DRCL (defined retrievable clinical lexicon) to be retrieved from lexicon storage 14 and displayed at the client device 13. The clinician then selects a subset of words and/or phrases from the DRCL, which selected words and/or phrases are then used to generate a clinical medical record for that patient encounter.

In the illustrated system 10, patient information obtained via a client device 13, or from other input devices, is stored in patient information storage 15 (e.g., one or more databases) that is in communication with the Sequoiah server 20. Exemplary patient information that can be stored according to embodiments of the present invention includes, but is not limited to, present illness information 15a, such as anatomical information and medication information; past history information 15b, such as medication information, family history information (genetic tree information), previous illnesses and/or procedures information, allergy information, immunization information, and social history information; physical examination information 15c; laboratory results 15d; x-ray exams 15e; demographical information 15f; and billing and insurance information 15g.

Preferably, patient information for use in accordance with embodiments of the present invention is stored in, and retrieved from, one or more databases. However, other data storage technologies may be utilized without limitation. As is known by those of skill in the art, a database is a collection of data that is organized in “tables.” A database typically includes a database manager that facilitates accessing, managing, and updating data within the various tables of a database. Exemplary types of databases that can be used to implement embodiments of the present invention include, but are not limited to, relational databases, distributed databases (databases that are dispersed or replicated among different points in a network), and object-oriented databases. Relational, distributed, and object-oriented databases are well understood by those of skill in the art and need not be discussed further herein. Exemplary commercial databases that can be used to implement embodiments of the present invention include, but are not limited to, IBM's DB2® database, Microsoft's SQL server database, and other database products, such as those from Oracle, Sybase, and Computer Associates.

It is understood that, in alternative embodiments of the present invention, patient information storage 15 and lexicon storage 14 can be combined in a single storage unit.

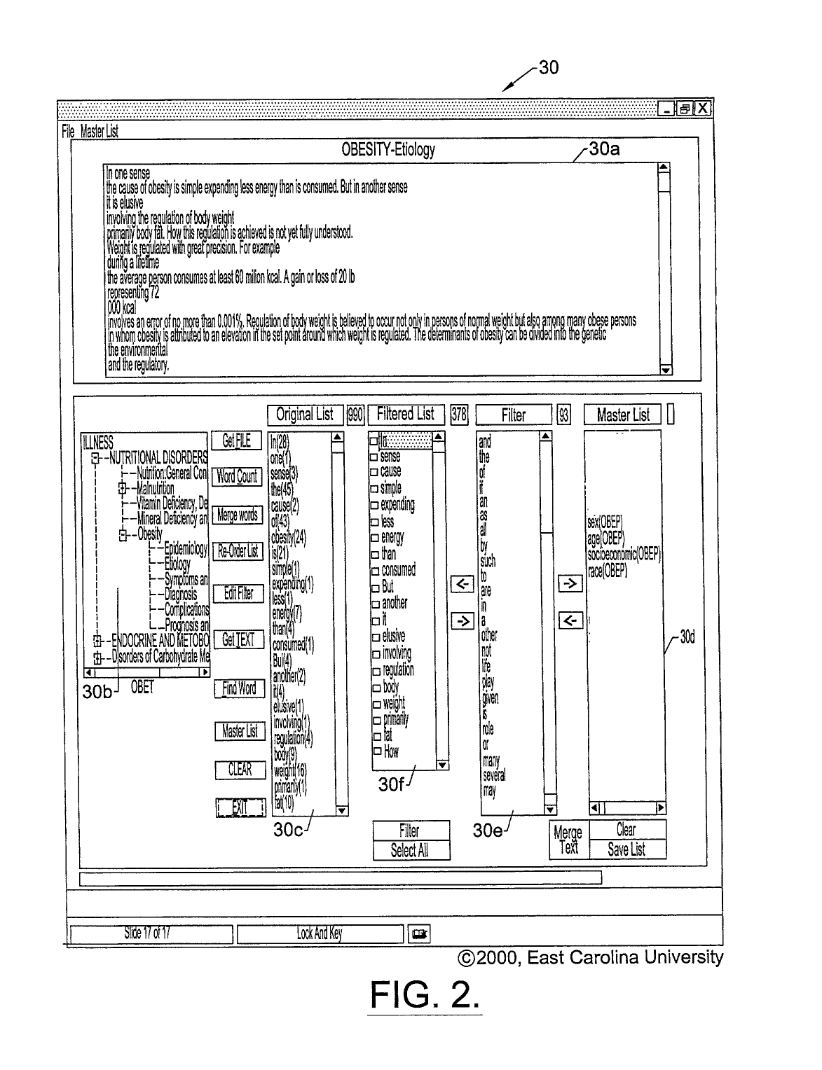

In the illustrated embodiment, the Sequoiah server 20 is configured to implement at least the operations described below with respect to FIGS. 3-6 and 7-8. For example, the Sequoiah server 20 according to embodiments of the present invention is configured to receive information from one or more client devices 13 and store this information in patient information storage 15. The Sequoiah server 20 according to embodiments of the present invention is configured to retrieve one or more lexicons from storage 14 and display these lexicons via a client device 13.

The Sequoiah server 20 according to embodiments of the present invention is configured to allow clinicians to add information to, and delete information from, one or more lexicons (DRCLs), as described below. Moreover, the Sequoiah server 20 executes applications that are configured to “learn” (i.e., modify) a lexicon over time. For example, if a particular word or phrase has not been used for a predetermined period of time, the Sequoiah server 20 may remove this word or phrase from one or more DRCLs. In addition, a particular word or phrase may be added to a DRCL either through new usage by a clinician and/or appearance in new publications. Preferably, additions and deletions of words and phrases is overseen and approved by a medical director or other person of authority.

In the course of a patient encounter, the interview process between patient and clinician (particularly a new patient) will frequently elicit information concerning a prior medical treatment and/or an existing medical condition that may affect how the medical record for that patient is prepared. Preferably, medical words and phrases are arranged in primary, secondary, and tertiary lexicons (DRCLs) with appropriate cross-links for efficient presentation of the words in an effective and logical sequence. Depending on the illness, there may be more or fewer DRCLs as compared with other illnesses. According to embodiments of the present invention, various ones of these additional DRCLs may be utilized in conjunction with preparing medical records.

The Sequoiah server 20 according to embodiments of the present invention is configured to receive search requests from client devices 13, conduct various searches using information stored in patient information storage 15, and return results of searches to a client device 13. The Sequoiah server 20 is capable of converting population data for statistical analysis and generating various reports in real time without requiring a review of paper records. For example, using the present invention, a clinician can determine answers to such questions as: “what is the infection rate after cardiac surgery for a population?”, “what is complication rate following laparoscopic cholecystectomy?”, and “how effective is a new beta-blocker in preventing myocardial infarctions?” Preferably, the Sequoiah server 20 is configured to be used in conjunction with various commercially available statistical analysis software.

Various patient information may be entered and stored in patient information storage 15 via other data input sources 17 (by clinicians and non-clinicians and/or via other computer systems) that communicate directly with patient information storage 15, independently of the Sequoiah server 20. For example, demographical information 15f and billing/insurance information 15g may be entered directly into patient information storage 15 by various non-clinicians using other computing devices and/or systems. Preferably, the Sequoiah server 20 is configured to handle data in various formats and generated from various other computing systems.

According to other embodiments of the present invention, program code necessary to provide one or more DRCLs may be located peripherally rather than in the Sequoiah server 20. Each client device 13 may be periodically docked or connected to the Sequoiah server 20 for transfer of clinical medical records generated during one or more patient encounters. Various implementations of the present invention may be utilized so long as the system 10 is configured to store for common searching a plurality of electronic clinical medical records generated from a plurality of patient encounters.

Referring to Fig. 1B, a block diagram of a data processing system 21 for use in implementing the Sequoiah server 20 (FIG. 1A), according to embodiments of the present invention, is illustrated. The illustrated data processing system 21, includes a processor 22, an operating system 23, a web server 24, and various application programs 25.

Exemplary data processing systems which may be utilized in accordance with embodiments of the present invention include, but are not limited to, Sun Microsystems®, Apple®, IBM®, and IBM®-compatible personal computers and workstations. However, it is to be understood that various computing devices and processors may be utilized to carry out embodiments of the present invention without being limited to those enumerated herein. An exemplary operating system 23 may include, but is not limited to, LINUX®, UNIX, Windows 98®, Windows 2000®, and Windows NT®.

The Web server 24 is configured to handle communications with client devices 13 (FIG. 1A) and other devices that are in communication with the communications network 12 (FIG. 1A). Web servers are well understood by those of skill in the art, and need not be described further herein. Exemplary Web servers that may be utilized in accordance with embodiments of the present invention include Apache, available from the Apache Server Project, http://www.apache.org; Microsoft's Internet Information Server (IIS), available from Microsoft Corporation, Redmond, Washington; and Netscape's FastTrack® and Enterprise™ servers, available from America Online, Inc., Dulles, Va. Other Web servers that may be utilized include, but are not limited to, Novell's Web Server for users of its NetWare® operating system, available from Novell, Inc., San Jose, Calif.; and IBM's family of Lotus Domino® servers, available from International Business Machines Corporation, Armonk, N.Y.

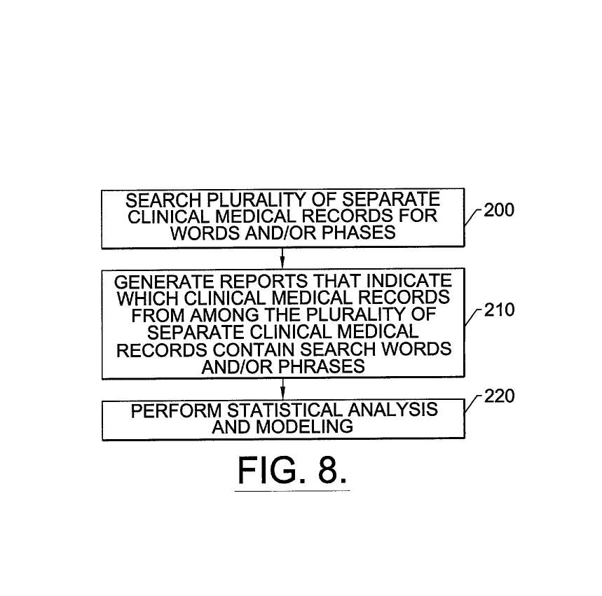

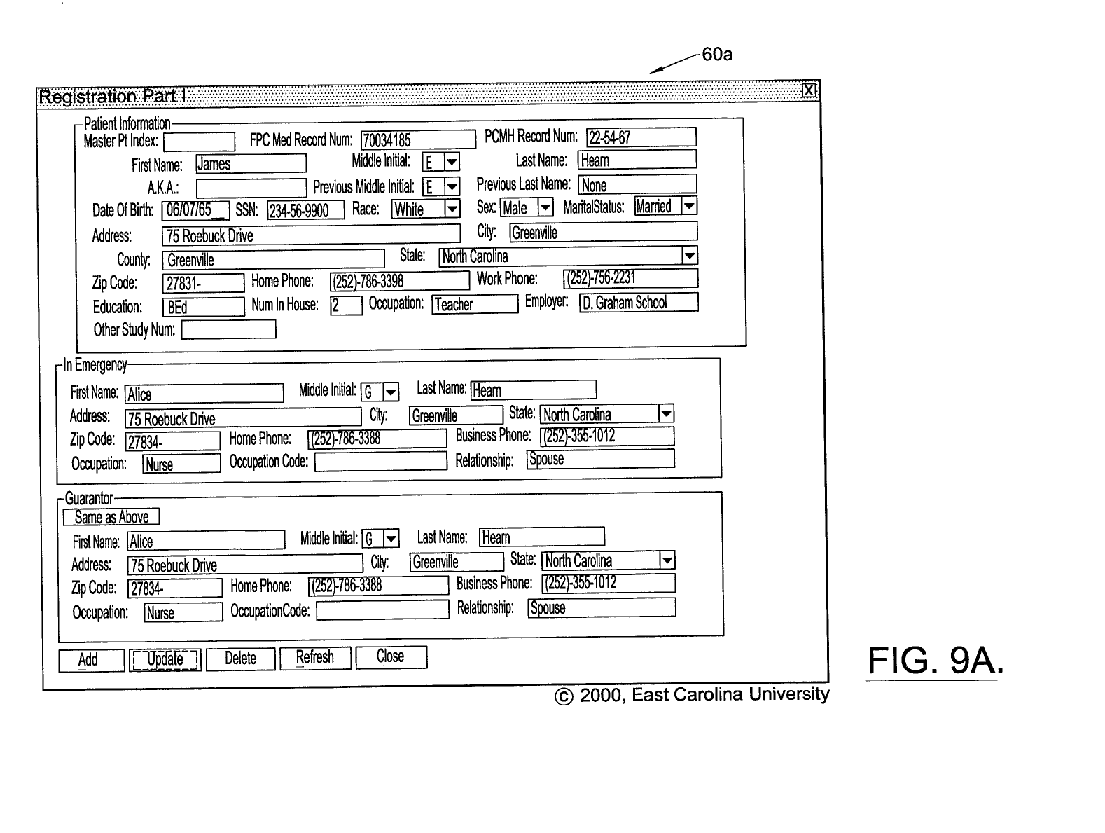

Application programs 25 for carrying out operations represented by the flowchart blocks of FIGS. 7-8 may include applications associated with retrieval and display of lexicons (DRCLs) 25a, medical record building 25b, medical record display 25c, lexicon modification 25d, medical record search and analysis 25e. Each of these various application programs may run on the operating system 23, as would be understood by those of skill in the art.

### Lexicon Development and Maintenance

According to embodiments of the present invention, DRCLs for various illnesses may be initially created by parsing medical texts and materials for words and phrases associated with various illnesses, other medical categories, etc. An application program, referred to as a lexicon filter, is employed to index medical texts and articles, extract relevant words and phrases therefrom, and place these words and phrases into appropriate DRCLs in accord with current medical logic. In addition, the filter is utilized to maintain existing DRCLs up-to-date by indexing subsequent versions of medical texts (as well as other sources of information) and adding new words and/or phrases (as well as modifying existing words and/or phrases).

A filter according to embodiments of the present invention may execute on the Sequoiah server 20 (FIG. 1A) or may execute on a remote data processing system. In the illustrated embodiment of FIG. 1A, a remote data processing system 16 is provided on which a filter executes for developing and maintaining DRCLs. The illustrated data processing system 16 (referred to as the “Lexicon Filter”) is configured to extract relevant words and phrases from medical texts and other sources and place them into appropriate DRCLs within the lexicon storage 14. The Lexicon filter system 16 is connected to the communications network 22 and is configured to extract relevant words and phrases from remote, third party data sources 27 and place these extracted words and phrases into appropriate DRCLs. Exemplary third party data sources include, but are not limited to, databases maintained by hospitals, health care providers, insurance companies, and federal agencies.

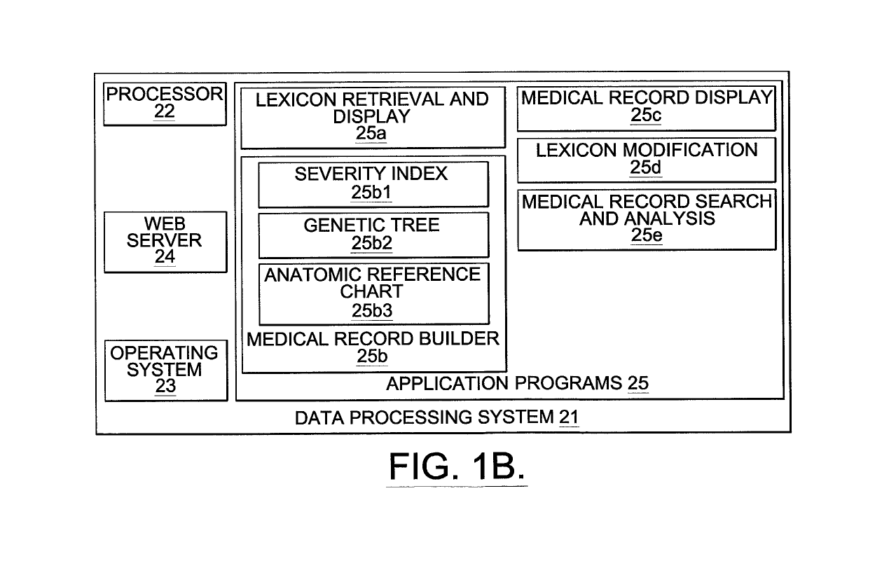

FIG. 2 illustrates a user interface 30 associated with a filter for extracting relevant words and phrases from various data sources and placing them into appropriate DRCLs. A data source in electronic format (e.g., a CD-ROM of a medical text, an electronic database, etc.) is read by the filter. A portion of the data source is displayed within window 30a of the illustrated user interface 30. Lists of existing DRCLs to which various extracted words and phrases may be added are displayed in hierarchical order in window 30b.

Words and phrases extracted from the data source displayed within window 30a are listed in window 30c with a number adjacent thereto indicating the number of occurrences of the respective word or phrase in the data source. The words and phrases displayed in window 30c are also indexed to facilitate later search and retrieval efforts, as would be understood by those of skill in the art. A list of indexed words and phrases is displayed in window 30d with an indication of the DRCL to which the respective words and phrases have been added.

Words and phrases that are “filtered” from the data source (i.e., that are excluded from indexing) are listed in window 30e. As would be understood by those of skill in the art, such terms include often repeated words such as “and”, “the”, “of”, etc. In window 30f, a list of additional words and phrases that can be removed from indexing are displayed. For example, the term “in” displayed within window 30f could be selected for exclusion from indexing, as would be understood by those of skill in the art.

### Medical Record

Conventionally, and as would be understood by those skilled in the art, a medical record includes the following components: introductory sentence; a chief complaint; a present illness identification; past medical history; family medical history; social medical history; physical examination information; and impressions. An introductory sentence may include such information as a patient's name, age, sex, occupation, and marital status, as well as an identification of a referring doctor and an accepting doctor. A chief complaint includes a description of an ailment or illness in the words of the patient. A present illness, as described above, is an initial illness of a patient as determined by a clinician.

Past medical history may include information about a patient such as allergies, immunizations, growth and development, hospitalizations, operations, and review of body systems. Family medical history may include information about illnesses of various family members. Social medical history may include various information tangentially related to a patient's health. An example of social medical history may include identifying whether a patient that cannot drive has access to transportation. Physical examination information includes information obtained during an examination of a patient. Impressions (i.e., diagnoses) may include laboratory information, x-ray reports, consultations, prescriptions, and the like.

Each of the above-described portions of a medical record may have respective DRCLs associated therewith that can be presented to a clinician in accordance with embodiments of the present invention.

### Medical Record Generation

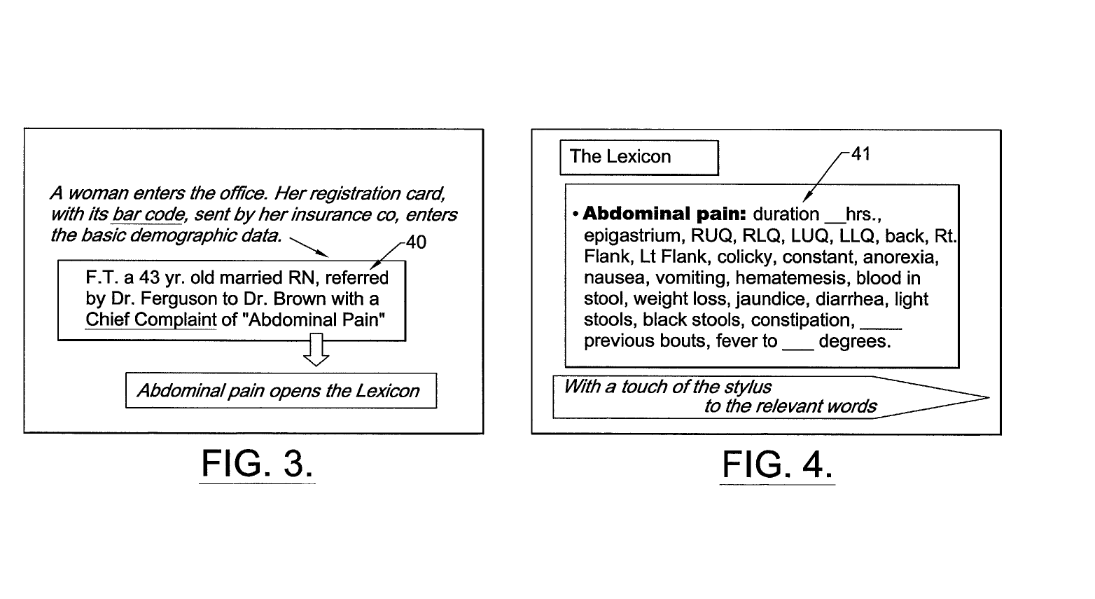

FIGS. 3-6 schematically illustrate a clinician-patient encounter in accordance with embodiments of the present invention, carried out on a touch-pad display of a client device. As illustrated in FIG. 3, basic demographic data 40 about a patient has been entered into a client device along with the patient's “chief complaint” (“abdominal pain”). The clinician identifies the present illness as “abdominal pain” and, in response, a DRCL 41 of words and phrases that relate to the present illness is displayed (FIG. 4). Although in the illustrated embodiments of the present invention the clinician has identified a present illness, it is understood that any illness (past, present, or future) may be entered and one or more DRCLs associated therewith may be presented to a clinician.

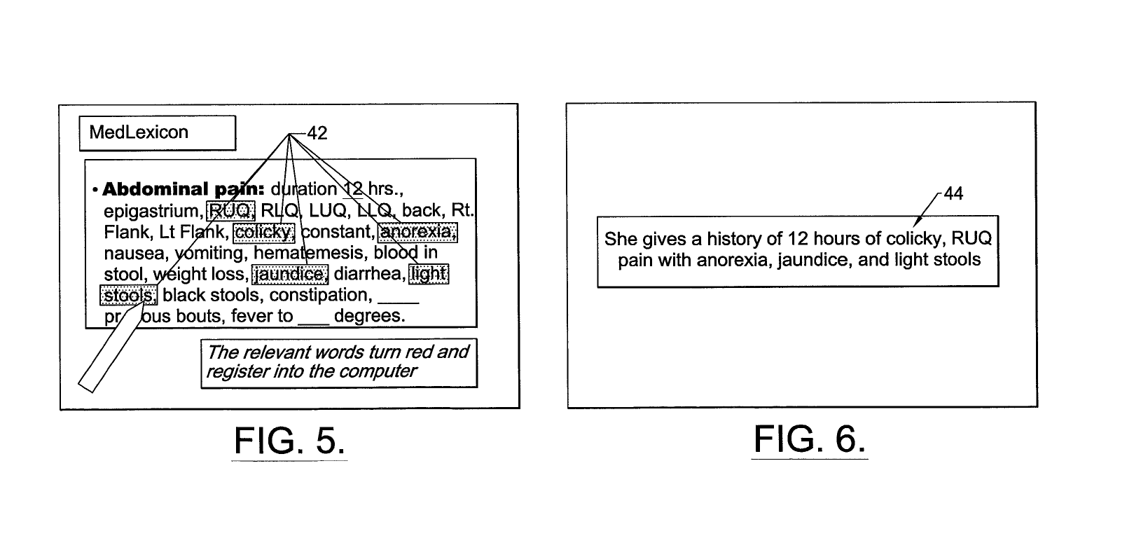

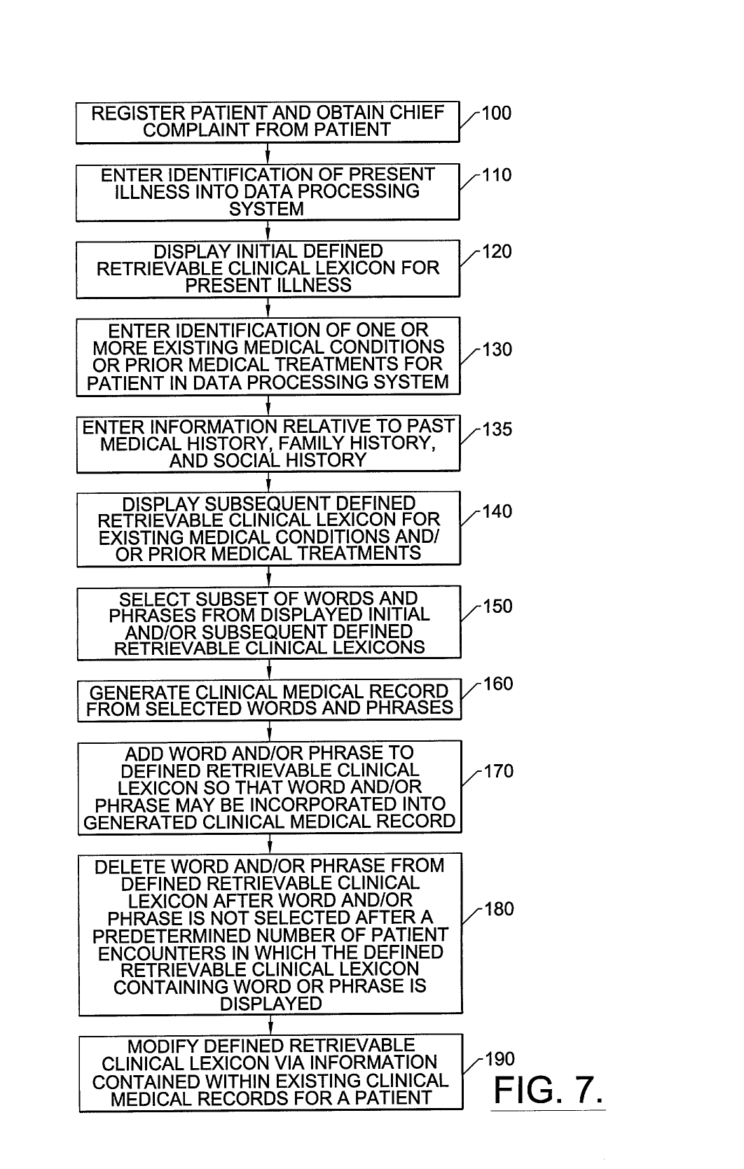

The display of the DRCL 41 provides a convenient prompt of questions to ask the patient during the patient encounter. A subset of words and phrases 42 that are reported by the patient during the encounter are then highlighted (e.g., by stylus contact with a touch pad display) (FIG. 5), and a clinical medical record 44 is then generated (FIG. 6) using the selected words and phrases 42. The clinical medical record 44, which may or may not be displayed back to the clinician, is then stored via the Sequoiah server 21 (FIG. 1A) for subsequent searching and retrieval.

### Data Entry Features

According to embodiments of the present invention, various data entry features may be provided that facilitate the generation of electronic medical records. These embodiments include, but are not limited to, a severity index, a genetic tree, and an anatomic reference chart. A severity index may be provided that is configured to convert the severity of patient symptoms (subjective descriptions by patients) and signs (objective findings by health providers) into numerical data for comparison at subsequent visits and for the evaluation of severity of disease and efficacy of treatment. For example, an indication of the severity of a patient's headache may be indicated using a scale of 1 to 10. A severity index offers a nonverbal method of entry that permits the rapid accession of charts that document the progress of disease.

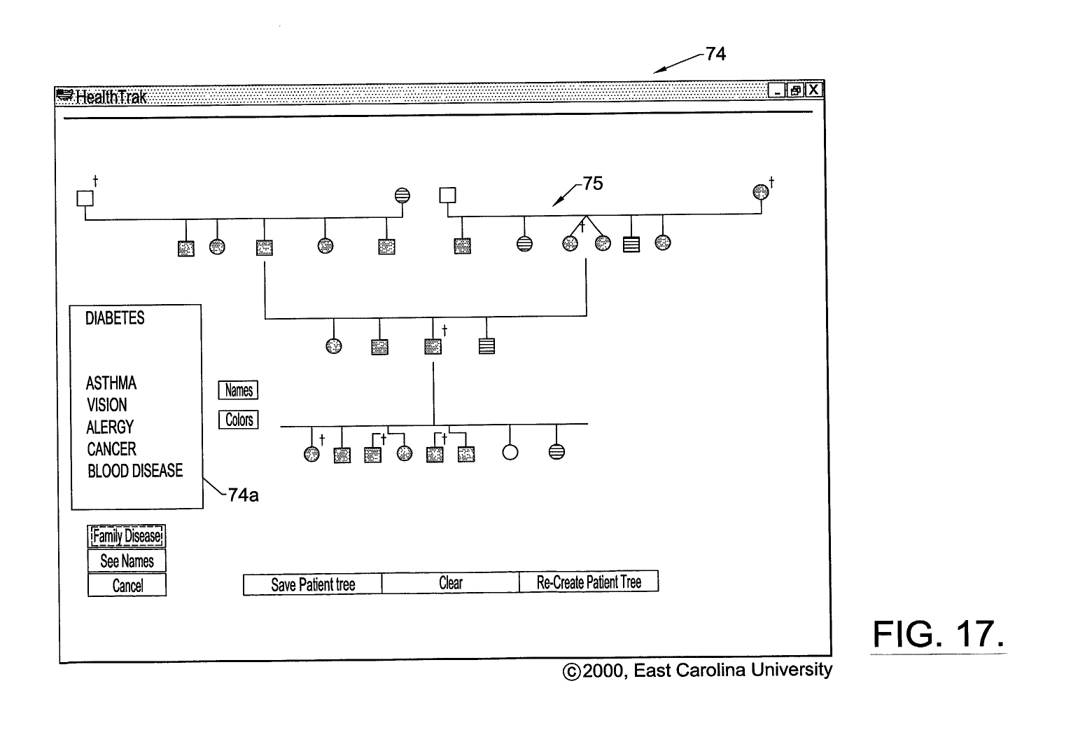

A genetic (or genomic) tree may be configured to convert entries about family members and the histories of their illnesses into a clear, color-coded graphic display that presents the various illnesses involving a family together with phenotypes, names, and relationships. If a genetic tree demonstrates that a member has carcinoma of the colon, a clinician is cautioned to warn the family that there are genetic implications and that certain tests need to be pursued to protect them. An exemplary genetic tree 75 is illustrated in the user interface 74 of FIG. 17 and is described in detail below.

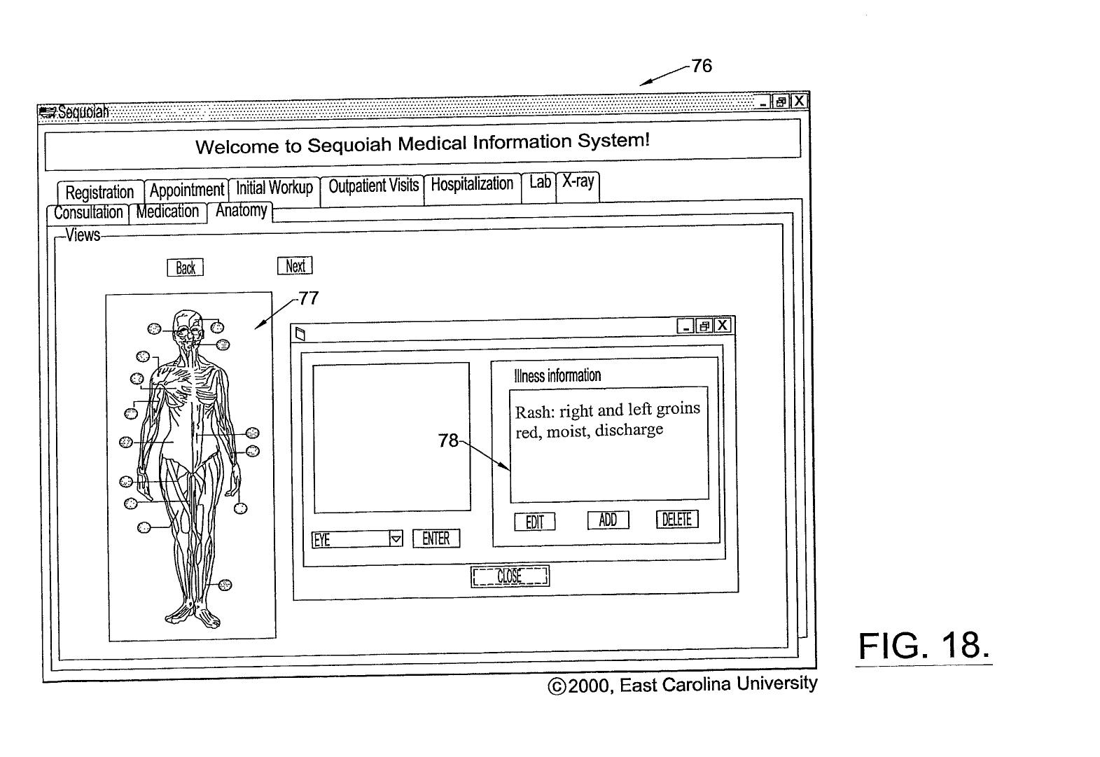

An anatomic reference chart may be presented to a clinician to facilitate data entry. The anatomic reference chart is configured to simplify anatomic entries especially for patients where a simple anatomic description such as “left wrist” does not suffice (i.e., such situations as indicating the extent of a burn or description of pain). An exemplary anatomic reference chart 77 is illustrated in the user interface 76 of FIG. 18 and is described in detail below.

Referring now to FIGS. 7-8, flow charts of systems, methods and/or computer program products for generating electronic clinical medical records during patient encounters, according to embodiments of the present invention, will now be described. Referring to FIG. 7, a patient is initially registered (Block 100) prior to an encounter with a clinician. During registration, various information is obtained from the patient including, but not limited to, personal information, insurance and billing information, and medical referral information. In addition, a patient's “chief complaint” about an illness may be obtained during registration.

During a subsequent encounter with a clinician, the clinician enters an identification of a present illness for the patient into a data processing system via an input device, such as the touch screen (Block 110). The identification of a present illness is a clinician's interpretation of a patient's chief complaint. In response to identifying a present illness, an initial DRCL is displayed for the present illness (Block 120). The DRCL includes words and phrases associated with the present illness. The words and phrases of the DRCL may be displayed in any order and arrangement, and may be displayed simultaneously.

The clinician may enter into the data processing system an identification of one or more existing medical conditions or prior medical treatments for this patient (Block 130) and information relative to past medical conditions, family history, and social history (Block 135). In response, one or more subsequent DRCLs may be displayed for the one or more existing medical conditions or prior medical treatments, as well as for past medical conditions, family history, and social history. (Block 140).

A subset of words and phrases can be selected by the clinician from the various displayed DRCLs during the patient encounter (Block 150). An electronic clinical medical record is then generated from the selected words and phrases (Block 160). A natural language generator may be utilized to generate medical records according to embodiments of the present invention. A natural language generator is a program that takes an abstract meaning representation, a set of grammar rules for a specific language and a dictionary and creates sentences for that language. Natural language generators are well known to those of skill in the art, and need not be described further herein.

According to other embodiments of the present invention, words and phrases can be added to a DRCL so that the words and phrases may be incorporated into the clinical medical record (Block 170).

According to other embodiments of the present invention, words and phrases may be deleted from a DRCL after the word and/or phrase has not been selected after a predetermined number of patient encounters in which the DRCL containing the word or phrase is displayed (Block 180). It is understood that more than one word and/or phrase may be deleted simultaneously.

According to other embodiments of the present invention, a DRCL may be modified via information contained within existing clinical medical records for a patient (Block 190).

Referring now to FIG. 8, according to other embodiments of the present invention, a searchable database of medical records (e.g., patient information storage 15 of FIG. 1A) for a plurality of patients can be created by repeating operations represented by Blocks 100-160 of FIG. 7 for a plurality of additional different patients during a plurality of different patient encounters. The plurality of separate clinical medical records can be searched for various words and/or phrases(Block 200) as would be understood by those of skill in the art. Moreover, reports can be generated that indicate which clinical medical records from among the plurality of separate clinical medical records contain the search words and/or phrases (Block 210). In addition, various statistical analyses and modeling studies can be performed using medical records generated in accordance with embodiments of the present invention for a plurality of patients (Block 220). Various statistical analysis techniques may be utilized including, but not limited to regression analysis and multivariate analysis.

Embodiments of the present invention may be particularly advantageous for performing population studies. For example, studies such as “determining the number of deaths from the population of men that received prescriptions for a particular drug” can be performed quickly and accurately. Moreover, clinical trial studies may be performed using information stored within medical records generated and modified in accordance with embodiments of the present invention.

Exemplary user interfaces for implementing embodiments of the present invention will now be described. It is understood that the user interfaces described herein are for illustrative purposes, and that embodiments of the present invention can be implemented via user interfaces having various configurations and styles. The present invention is not limited to use of the following user interfaces. Moreover, user interfaces displayed via small, handheld devices may be utilized.

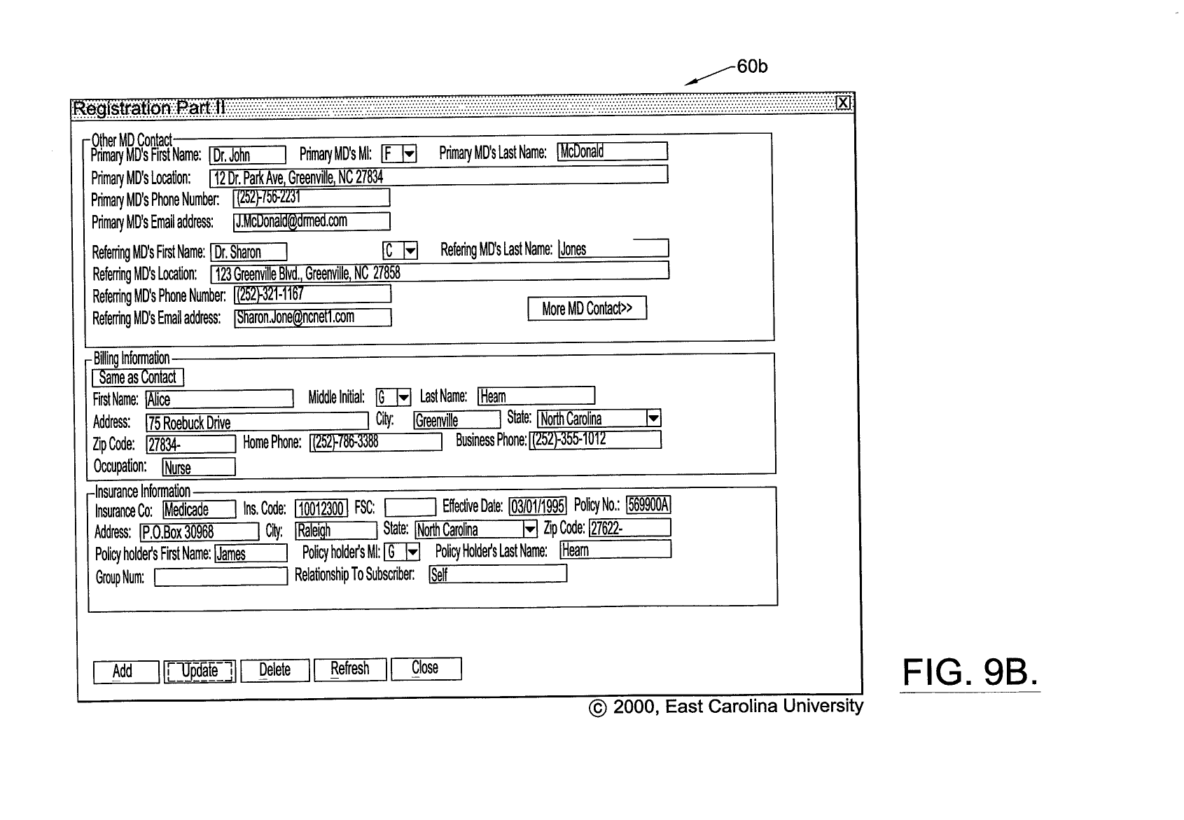

FIGS. 9A-9B illustrate exemplary registration forms 60a, 60b wherein various data associated with a patient (e.g., personal information, billing information, referring physician information, and insurance information) can be entered into a data processing system, according to embodiments of the present invention. Typically, registration forms 60a, 60b are completed at a registration desk prior to a patient's meeting with a clinician. Alternatively, all or portions of registration forms 60a, 60b may be completed by importing information stored on a smart card or stored at a remote location (e.g., insurance company information stored elsewhere and accessible via the Internet).

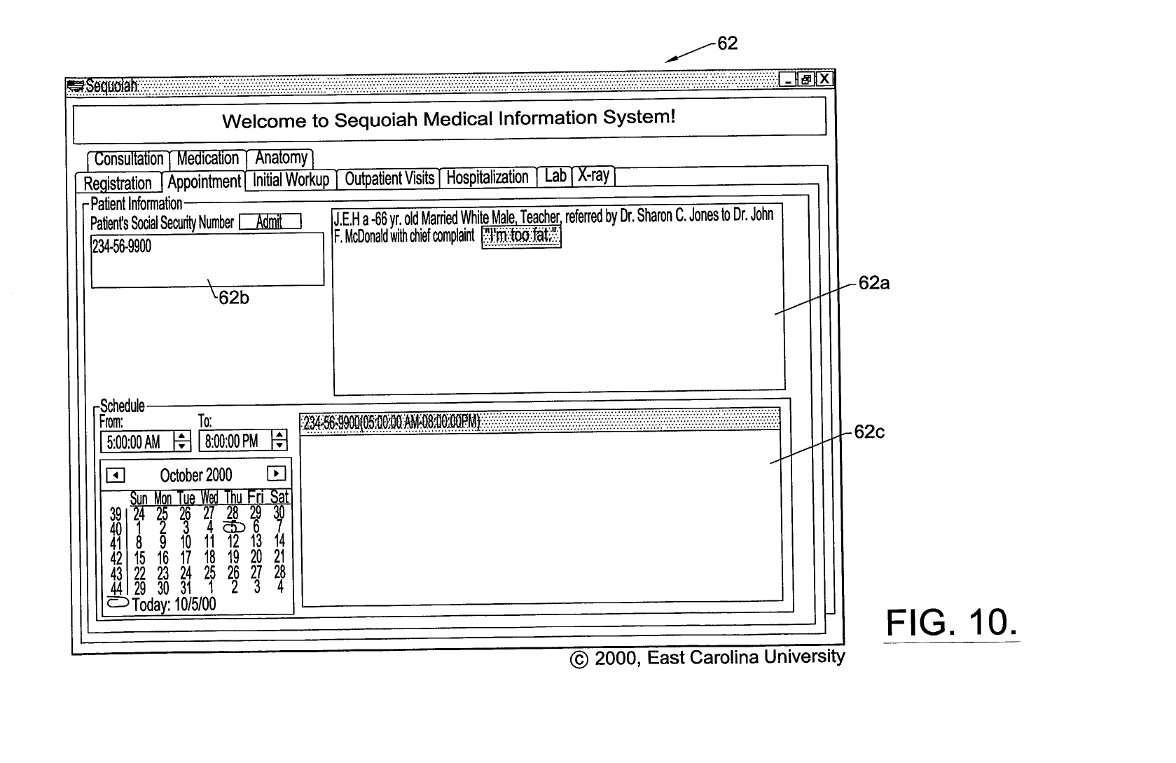

FIG. 10 illustrates an exemplary user interface 62 that is presented to a clinician at the beginning of a patient encounter. The patient's chief complaint and other demographic information may be entered into window 62a by the clinician. Alternatively, the patient's chief complaint and other demographic information may be entered into window 62a from registration data entered into the registration forms 60a, 60b of FIGS. 9A-9B. Various other information is viewable via the illustrated user interface 62, such as the patient's social security number and appointment time and date in windows 62b, 62c, respectively.

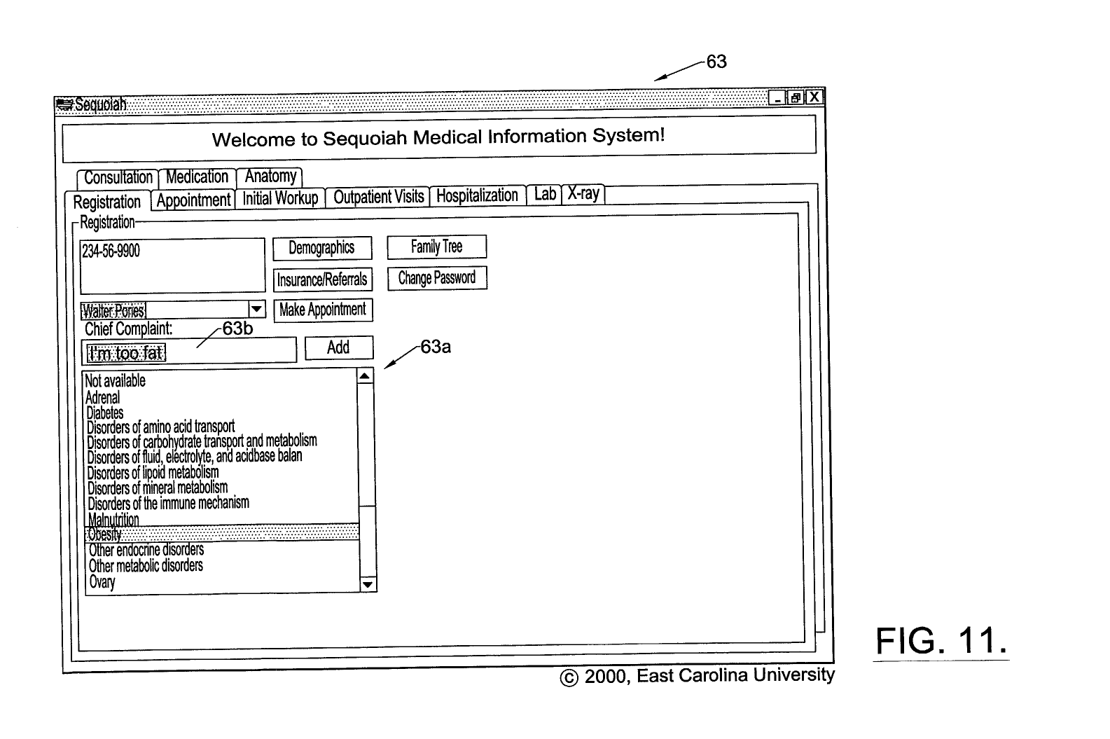

FIG. 11 illustrates an exemplary user interface 63 for use by a clinician in selecting a present illness and, subsequently, a DRCL for use in generating a medical record for the patient. The illustrated user interface 63 includes a scrollable selection menu 63a from which a clinician can select a present illness of a patient during a patient encounter based upon the patient's chief complaint. In the illustrated user interface 63, the patient's chief complaint is “I'm too fat”, and is displayed in window 63b. The clinician has selected “obesity” as the present illness from the selection menu 63a.

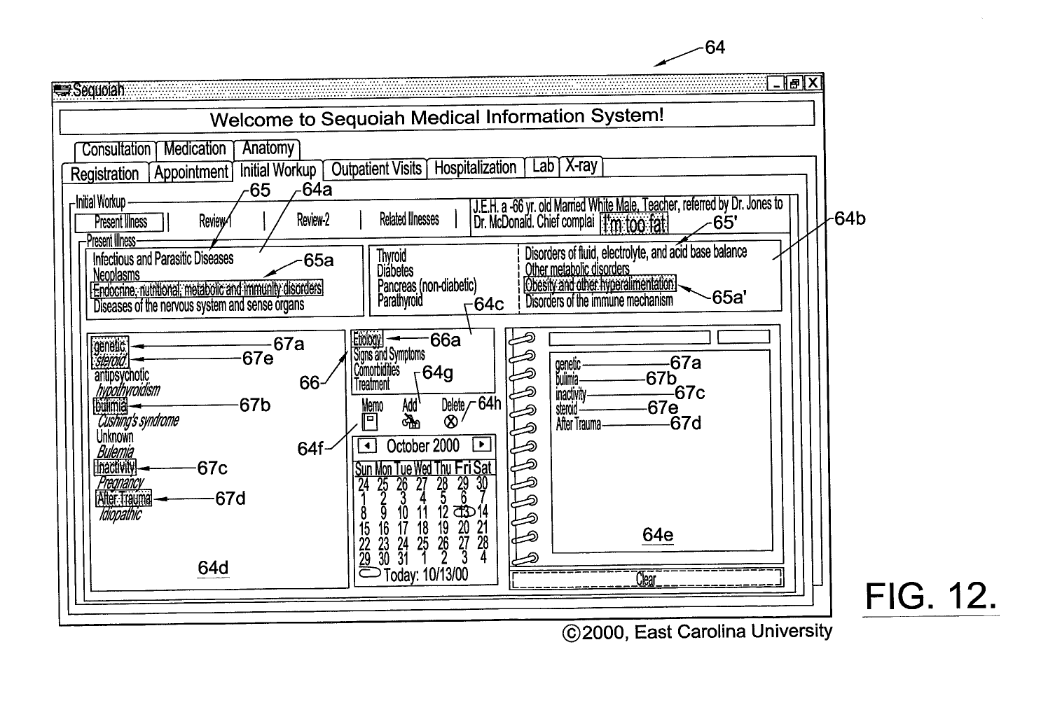

FIGS. 12-15 collectively illustrate a progressively generated medical record for a patient for a particular encounter with a clinician.

FIG. 12 illustrates an exemplary user interface 64 for use by a clinician in quickly entering various health information about a patient during an encounter, according to embodiments of the present invention. In response to selection of a present illness (e.g., via FIG. 11), a plurality of selectable lexicons (DRCLs) 65 are displayed in window 64a. In the illustrated user interface 64, the clinician has selected a primary DRCL 65a, entitled “Endocrine, nutritional, metabolic and immunity disorders.”

In response to selection of the primary DRCL 65a, a plurality of secondary DRCLs 65′ associated with the primary DRCL 65a are displayed in window 64b. In the illustrated user interface 64, the clinician has selected a secondary DRCL 65′a, entitled “Obesity and other hyperalimentation”.

In response to selection of the secondary DRCL 65b, a plurality of clinical categories 66 are displayed within window 64c. The displayed clinical categories 66 include “etiology”, “signs and symptoms, “comorbidities”, and “treatment.” In the illustrated user interface 64, the clinician has selected the clinical category “etiology” 66a. In response to the selection of the clinical category “etiology” 66a, a plurality of words and phrases associated with the clinical category “etiology” 66a are displayed in window 64d. The words and phrases displayed within window 64d are displayed in alternating formats such as italics and bold to facilitate selection thereof by the clinician. The words and phrases displayed within window 64d represent the content of the selected primary and secondary DRCLs.

In the illustrated user interface 64, the clinician has selected the words “genetic” 67a, “bulima” 67b, “inactivity” 67c, “after trauma” 67d, and “steroid” 67e. Each of these words, upon selection by the clinician, is displayed within the window 64e and is used to build a medical record for the patient for this particular patient encounter.

The illustrated user interface 64 includes user-activatable icons 64f, 64g, 64h. Icon 64f, entitled “memo”, upon activation, allows a clinician to enter information into the patient's medical record for this particular encounter with respect to a particular word or phrase of a selected DRCL (e.g., similar to a note attached to a physical record). Icon 64g, entitled “add”, upon activation, allows a clinician to add a new word or phrase to the selected DRCL. Icon 64h, entitled “delete”, upon activation, allows a clinician to delete a word or phrase from the selected DRCL.

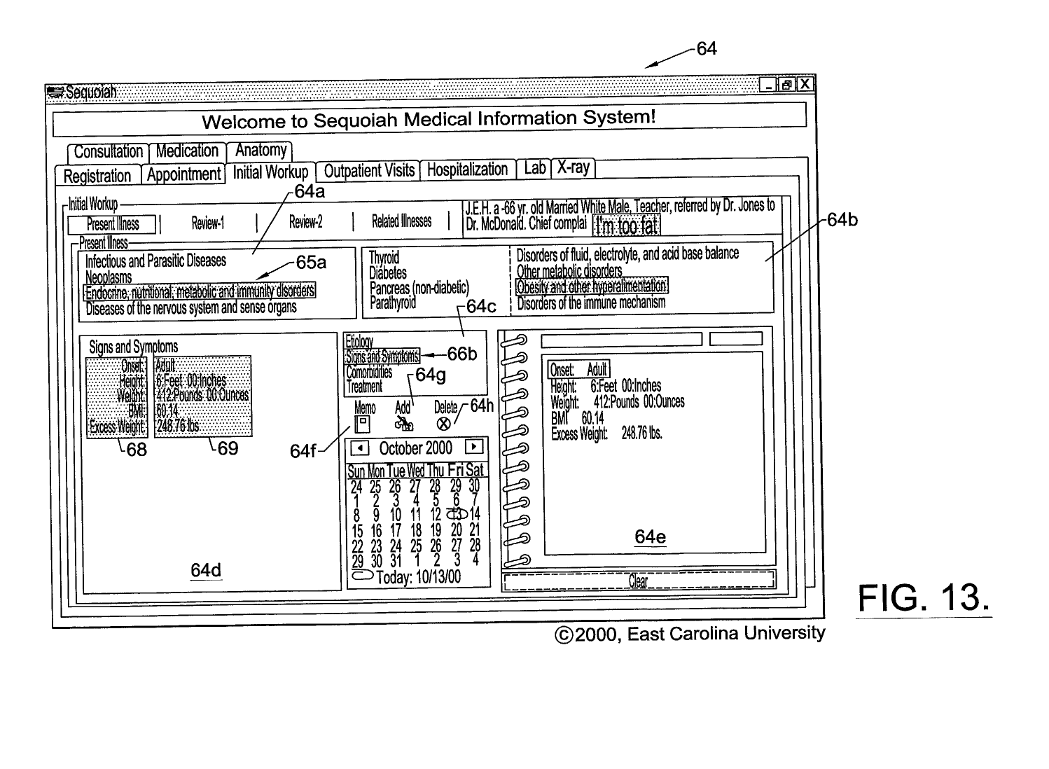

Referring now to FIG. 13, the clinician has selected the clinical category “signs and symptoms” 66b in window 64c. In response to the selection of the clinical category “signs and symptoms” 66b, a plurality of words and phrases 68 associated with the clinical category “signs and symptoms” 66b are displayed in window 64d. Each of the displayed words and phrases 68 relate to physical data about the patient and require the clinician to enter respective values 69 therefor. These values may be entered by the clinician in window 64d or may be obtained from other stored information about the patient, as would be understood by one of skill in the art. Each of the displayed words and phrases 68 and their respective values 69 have been selected by the clinician for entry into the patient's medical record for this encounter, as illustrated in window 64e.

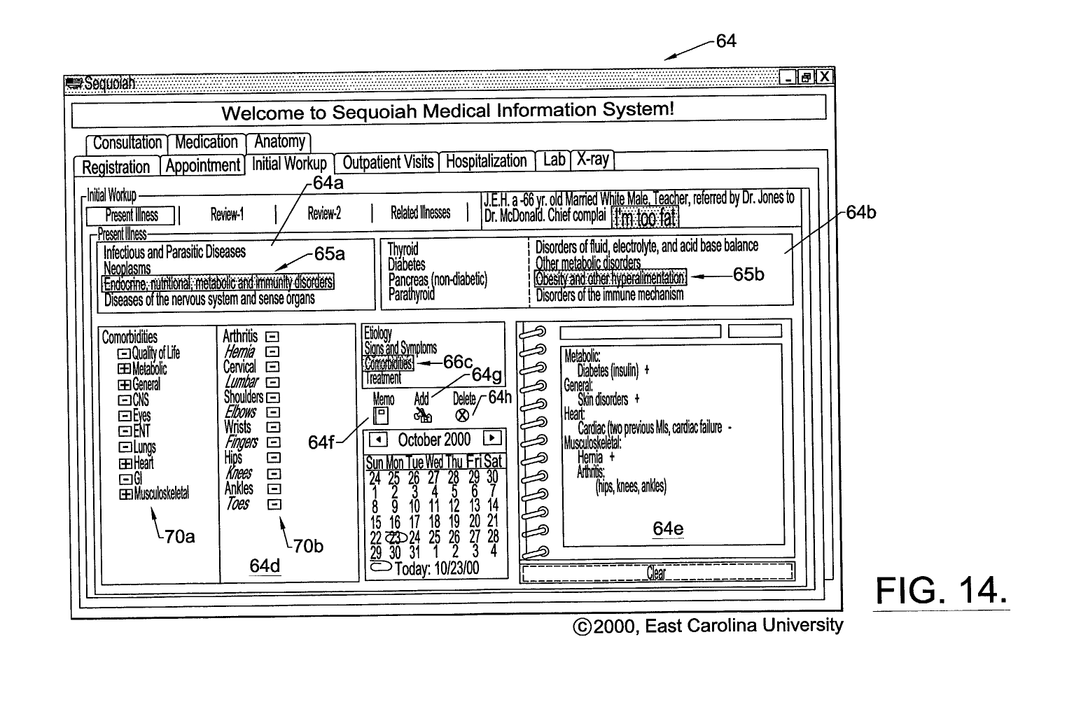

Referring now to FIG. 14, the clinician has selected the clinical category “comorbidities” 66c in window 64c. In response to the selection of the clinical category “comorbidities” 66c, a plurality of words and phrases 70a, 70b associated with the clinical category “comorbidities” 66c are displayed in window 64d. When a comorbidity, such as diabetes, is selected by the clinician, the DRCL for diabetes is presented to offer the clinician various words and phrases associated with the diabetes DRCL. In that way, information that the patient is currently taking insulin is derived. In the illustrated user interface 64, the clinician has selected various ones of the words and phrases 70a, 70b for entry into the patient's medical record for this encounter, as illustrated in window 64e.

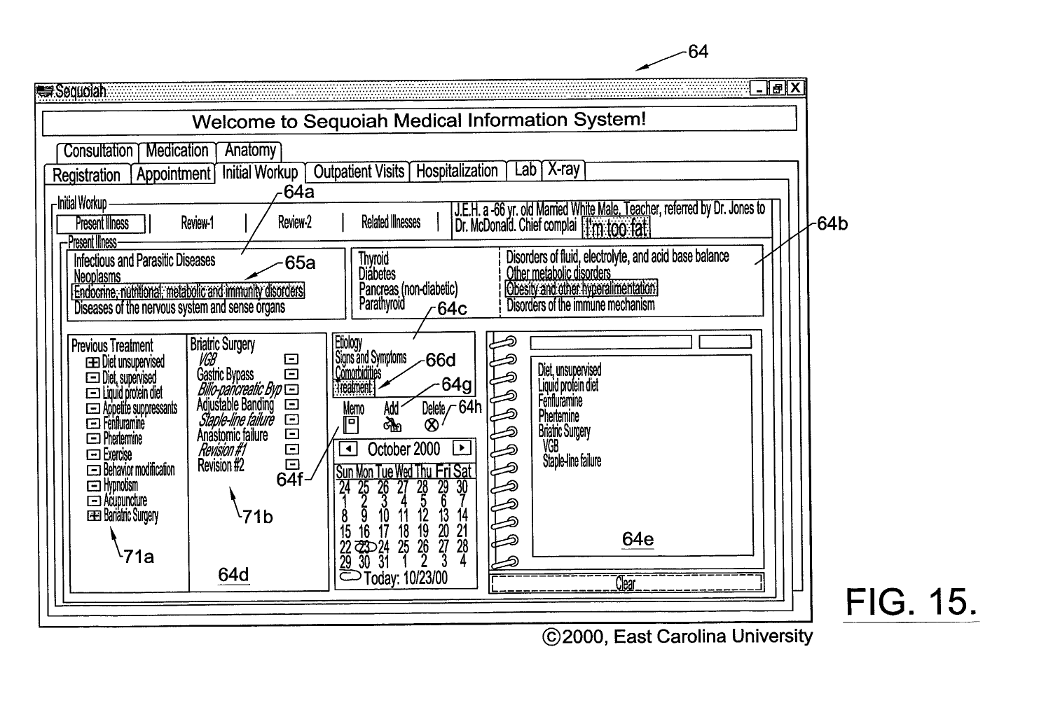

Referring now to FIG. 15, the clinician has selected the clinical category “treatment” 66d from window 64c. In response to the selection of the clinical category “treatment” 66d, a plurality of words and phrases 71a, 71b associated with the clinical category “treatment” 66d are displayed in window 64d. The clinical category “treatment” 66d relates to previous medical treatments the patient has received. In the illustrated user interface 64, the clinician has selected various ones of the words and phrases 71a, 71b for entry into the patient's medical record for this encounter, as illustrated in window 64e.

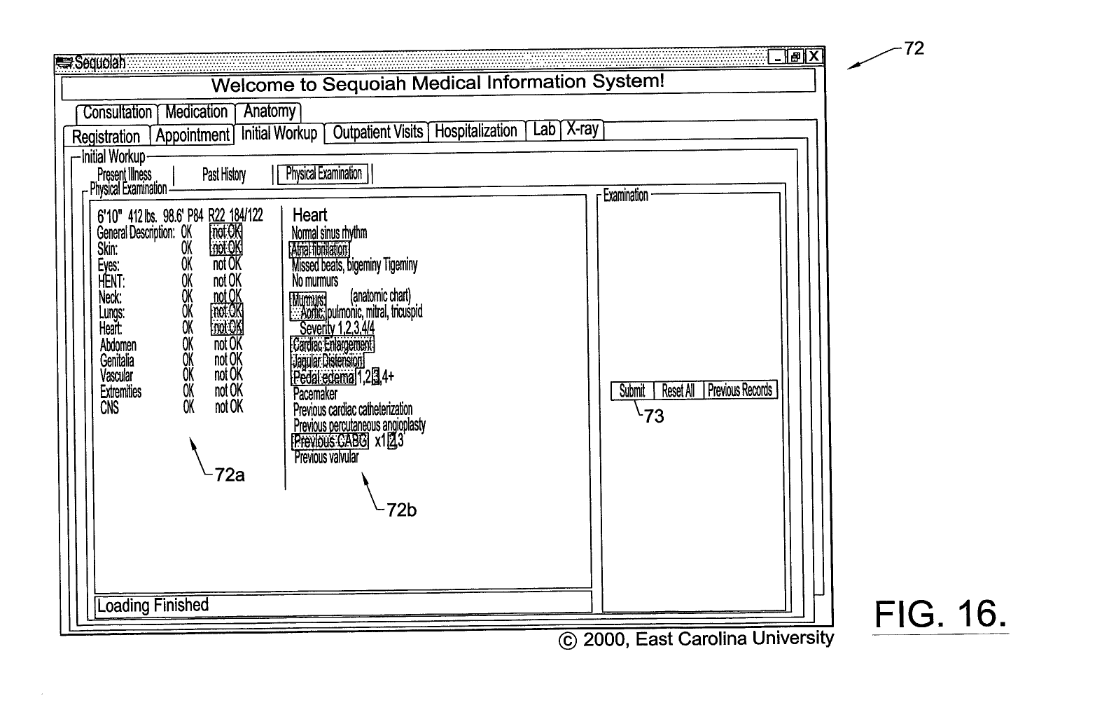

Referring now to FIGS. 16-18, various user interfaces that can facilitate the entry of various types of data by a clinician, according to embodiments of the present invention, are illustrated. In FIG. 16, a user interface 72 allows a clinician to quickly select either “ok” or “not ok” for various conditions of a patient during a physical examination of the patient (window 72a). The illustrated user interface 72 also allows the clinician to select various words and phrases associated with the physical examination of the patient (window 72b). Upon activation of the “submit” button 73, selected words and phrases are entered into the patient's medical record for this encounter.

FIG. 17 illustrates an exemplary user interface 74 that displays a family (genetic or genomic) tree 75 for the patient and wherein illnesses (listed in window 74a) of members of the patient's genomic tree 75 are identified and which can be included within a patient's medical records. The genomic tree 75 may be derived from information obtained during patient registration and/or interviews with the patient. Various illnesses of family members may be indicated by using colors and/or shading. Preferably, touching a family member's icon in the genomic tree 75 will display the name and, if available, other pertinent information about the family member. All of the information displayable via the genomic tree 75 can be entered into the patient's medical record.

FIG. 18 illustrates an exemplary user interface 76 for use by a clinician in quickly entering various anatomical information about a patient during an encounter, according to embodiments of the present invention. In many cases, words can describe anatomical areas fairly accurately (e.g., “left wrist”). However, in some instances, such as burn injuries, an anatomical chart can facilitate identification of various locations of injuries. By activating (e.g., clicking via a mouse, or touching via a stylus) designated portions of a displayed anatomic reference chart 77, an anatomical area of a patient can quickly be designated. In the illustrated user interface 76, a patient's eye has been selected using the anatomic reference chart 77 and information associated with the patient's eye has been entered in the box 78 by the clinician. Information displayed within box 78 can be entered into the patient's medical record.

It is understood that each of the illustrated user interfaces described above are preferably configured for use via a touch pad display. As such, a medical record can be generated quickly and easily while a clinician talks with a patient.

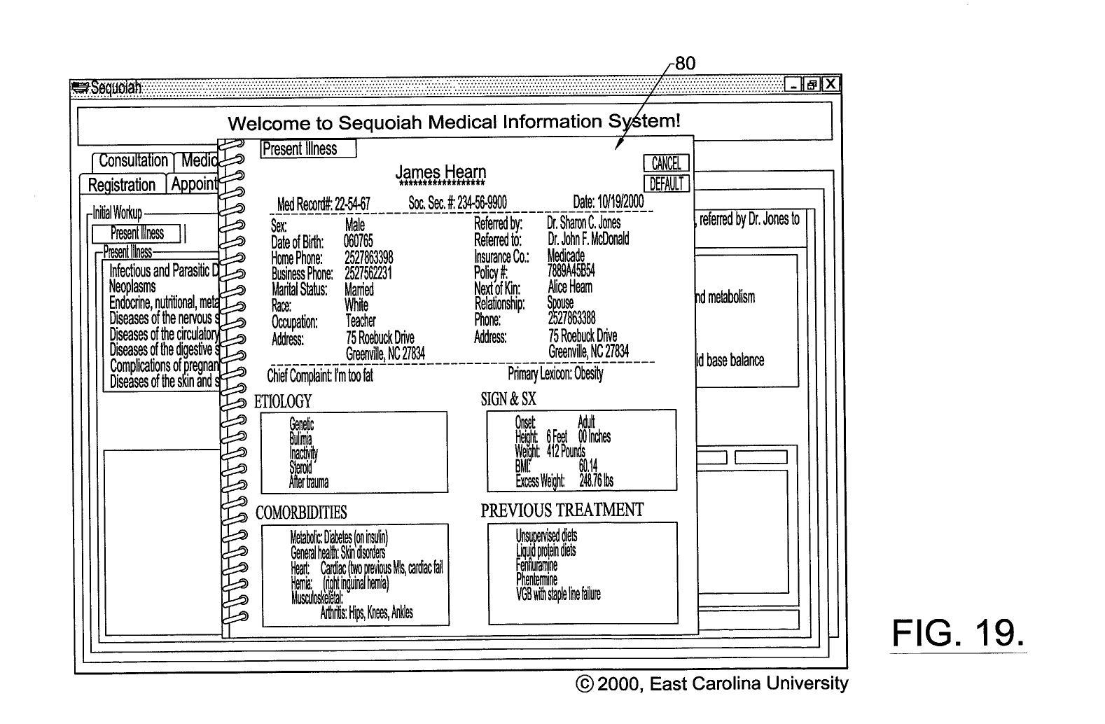

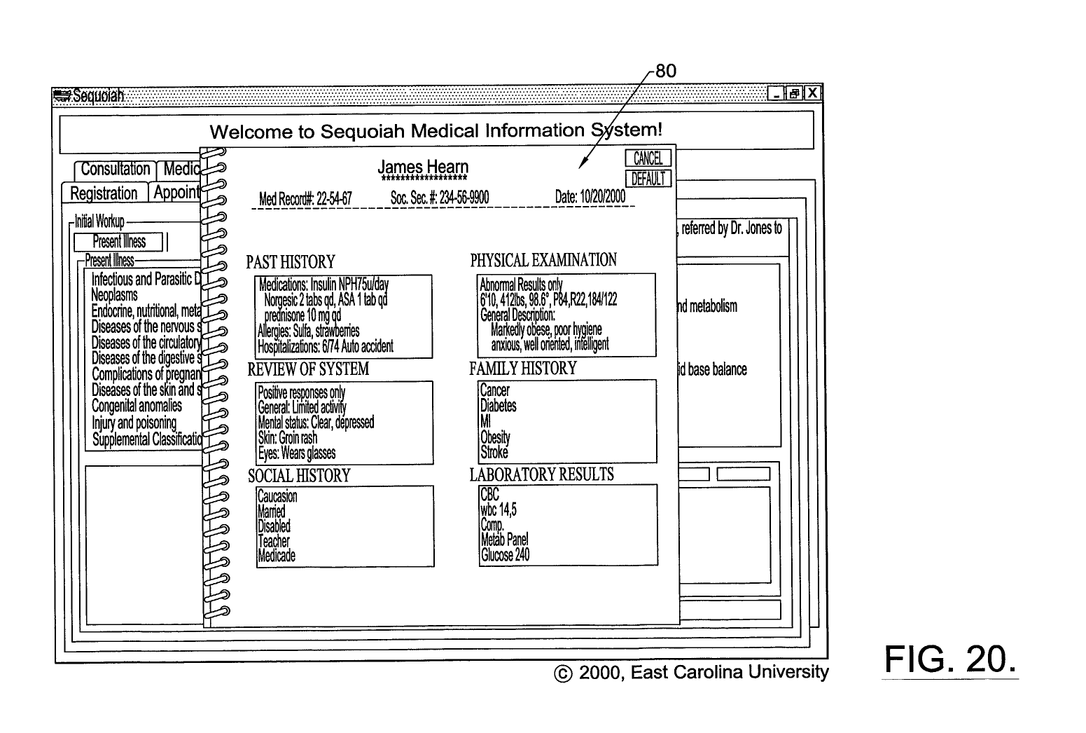

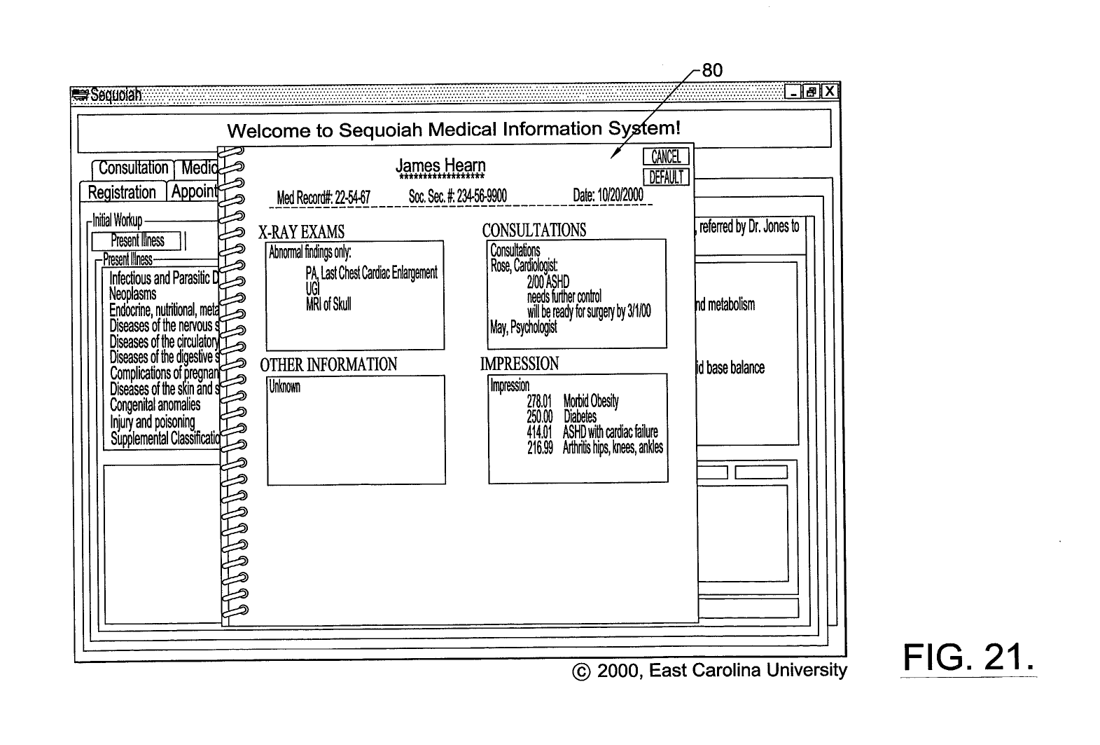

FIGS. 19-21 illustrate an electronic medical record 80 for a patient generated during an encounter with a clinician in accordance with embodiments of the present invention. The illustrated medical record 80 includes patient information obtained from various ones of the user interfaces described above.

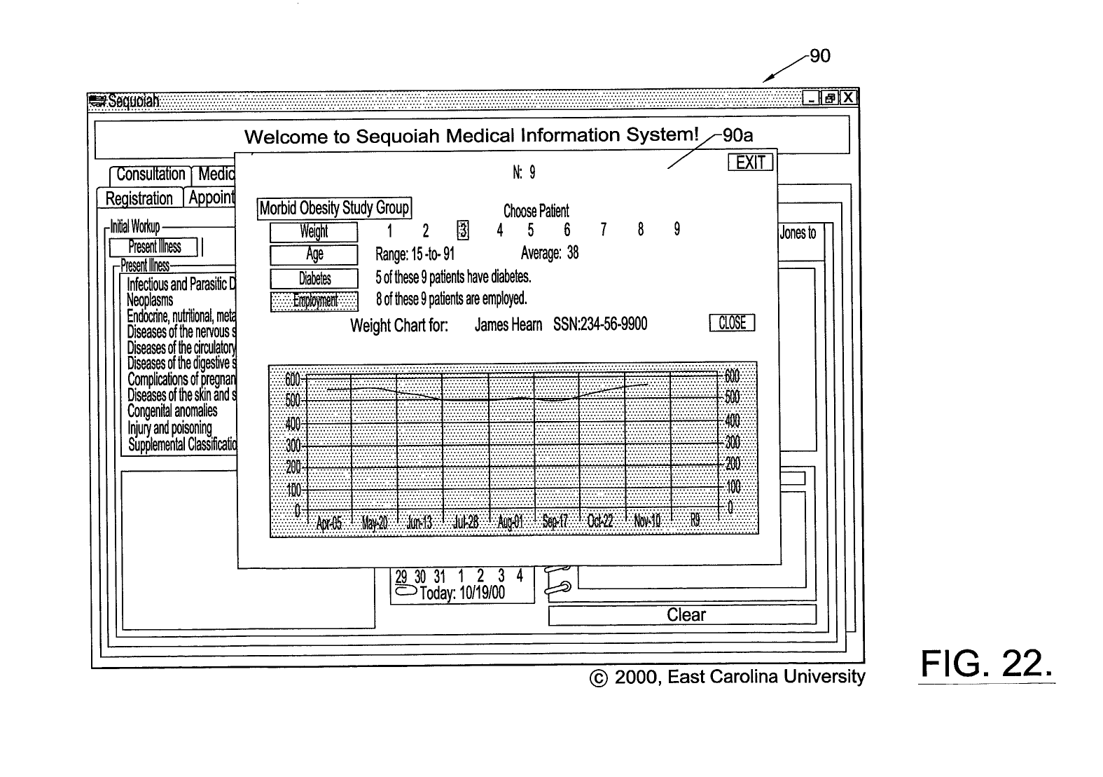

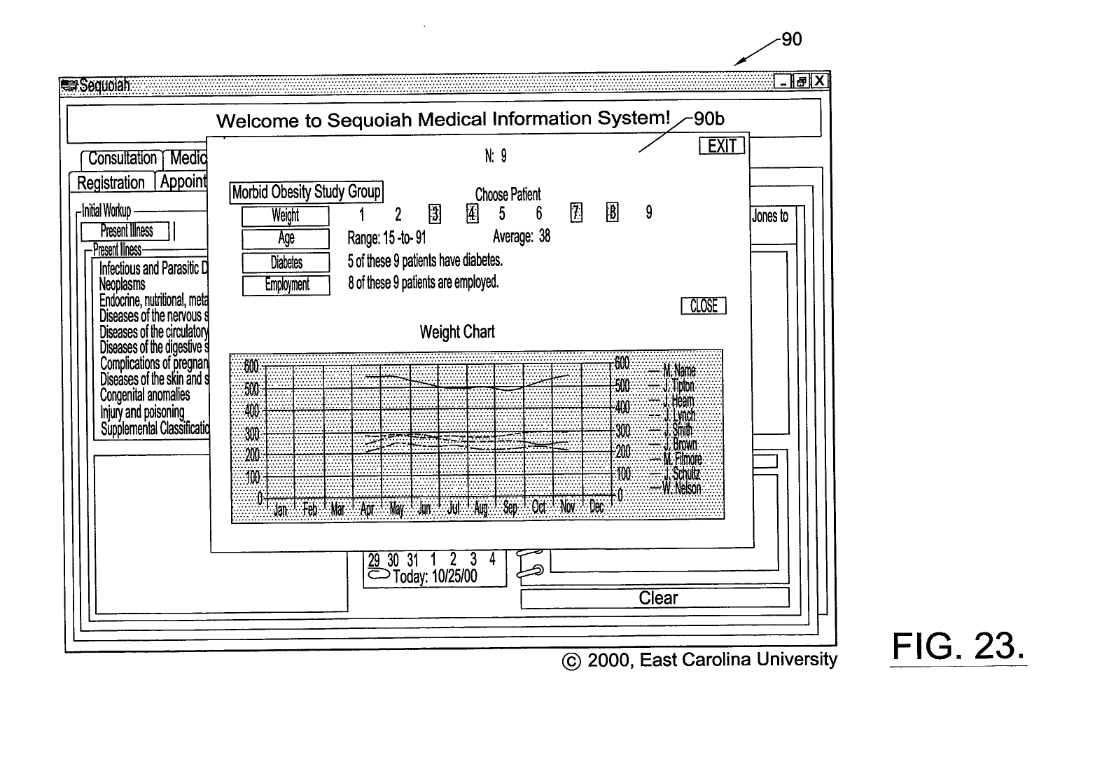

Referring now to FIGS. 22-23, various user interfaces illustrating statistical analyses that can be performed with medical records created in accordance with embodiments of the present invention are shown. In FIG. 22, numerical data accumulated over serial visits by a patient is plotted in a graph displayed within window 90a of user interface 90. In FIG. 23, numerical data accumulated over serial visits by a plurality of patients is plotted in a graph displayed within window 90b of user interface 90.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for generating an electronic clinical medical record from a given patient encounter, comprising the steps of:
(a) accepting entry of an identification of an illness for that patient into a data processing system via an input device;
(b) displaying an initial defined retrievable clinical lexicon for the illness via the input device, the defined retrievable clinical lexicon comprising words and phrases associated with the illness;
(c) accepting selection of a subset of words and phrases from the displayed defined retrievable clinical lexicon for the patient encounter; and then
(d) generating a clinical medical record from the selected subset of words and phrases.

2. The method according to claim 1, wherein step (b) comprises simultaneously displaying the words and phrases of the defined retrievable clinical lexicon.

3. The method according to claim 1, further comprising the step of:
(e) adding a word or phrase to the defined retrievable clinical lexicon after the displaying step so that the word or phrase may be incorporated into the clinical medical record.

4. The method according to claim 1, further comprising the step of:
(f) deleting a word or phrase from the defined retrievable clinical lexicon after the word or phrase is not selected after a predetermined number of patient encounters in which the defined retrievable clinical lexicon containing the word or phrase is displayed.

5. The method according to claim 1, wherein step (d) is carried out with a natural language generator.

6. The method according to claim 1, wherein the input device comprises a touch tablet display.

7. The method according to claim 1, wherein a previous clinical medical record exists for the patient, and wherein the defined retrievable clinical lexicon is modified via information contained within the previous clinical medical record.

8. The method according to claim 1, wherein step (c) further comprises accepting selection of patient anatomic information from a displayed anatomic reference chart.

9. The method according to claim 1, wherein step (c) further comprises accepting selection of a numeric indicator of severity of a patient condition.

10. The method according to claim 1, further comprising the step of:
(g) displaying information about medical conditions of members of a patient's family via a genetic tree.

11. A method for generating an electronic clinical medical record from a given patient encounter, comprising the steps of:
(a) accepting entry of an identification of an illness for the patient into a data processing system via an input device;
(b) displaying an initial defined retrievable clinical lexicon for the illness via the input device, the defined retrievable clinical lexicon comprising words and phrases associated with the illness;
(c) accepting entry of an identification of at least one existing medical condition or prior medical treatment for the patient into the data processing system via the input device;
(d) displaying a subsequent defined retrievable clinical lexicon for at least one of the existing medical condition or prior medical treatment via the input device;
(e) accepting selection of a subset of words and phrases from the displayed initial and subsequent defined retrievable clinical lexicons for the patient encounter; and then
(f) generating a clinical medical record from the selected subset of words and phrases.

12. The method according to claim 11, wherein steps (b) and (d) each comprise simultaneously displaying the words and phrases of the defined retrievable clinical lexicon.

13. The method according to claim 11, further comprising the step of:
(g) adding a word or phrase to the defined retrievable clinical lexicon after the displaying step so that the word or phrase may be incorporated into the clinical medical record.

14. The method according to claim 11, further comprising the step of:
(h) deleting a word or phrase from the defined retrievable clinical lexicon after the word or phrase is not selected after a predetermined number of patient encounters in which the defined retrievable clinical lexicon containing the word or phrase is displayed.

15. The method according to claim 11, wherein step (f) is carried out with a natural language generator.

16. The method according to claim 11, wherein the input device comprises a touch tablet display.

17. A method for generating a plurality of searchable electronic clinical medical records from a plurality of patient encounters between different patients and different clinicians, comprising the steps of:
(a) accepting entry into a data processing system via an input device an identification of an illness for a patient during a given patient encounter;
(b) displaying a defined retrievable clinical lexicon for the illness via the input device, the defined retrievable clinical lexicon comprising words and phrases associated with the illness;
(c) accepting selection of a subset of words and phrases from the displayed defined retrievable clinical lexicon;
(d) generating a clinical medical record from the selected subset of words and phrases for the patient encounter; then
(e) repeating steps (a) to (d) above for a plurality of additional different patients during a plurality of different patient encounters to create a plurality of separate clinical medical records for the plurality of patients;
(f) searching the plurality of separate clinical medical records for at least one word or phrase; and then
(g) generating a report indicating those separate clinical medical records from among the plurality of separate clinical medical records containing the at least one word or phrase.

18. The method according to claim 17, further comprising the step of (h) performing statistical analysis on the plurality of separate clinical medical records.

19. The method according to claim 18, wherein step (h) comprises performing regression analysis or multivariate analysis.

20. A system that generates an electronic clinical medical record from a given patient encounter, comprising:
means for accepting entry of an identification of an illness for that patient into a data processing system via an input device;
means for displaying an initial defined retrievable clinical lexicon for the illness via the input device, the defined retrievable clinical lexicon comprising words and phrases associated with the illness;
means for accepting selection of a subset of words and phrases from the displayed defined retrievable clinical lexicon for the patient encounter; and
means for generating a clinical medical record from the selected subset of words and phrases.

21. The system according to claim 20, wherein the means for displaying an initial defined retrievable clinical lexicon comprises means for simultaneously displaying the words and phrases of the defined retrievable clinical lexicon.

22. The system according to claim 20, further comprising means for adding a word or phrase to the defined retrievable clinical lexicon so that the word or phrase may be incorporated into the clinical medical record.

23. The system according to claim 20, further comprising means for deleting a word or phrase from the defined retrievable clinical lexicon after the word or phrase is not selected after a predetermined number of patient encounters in which the defined retrievable clinical lexicon containing the word or phrase is displayed.

24. The system according to claim 20, wherein the means for generating a clinical medical record from the selected subset of words and phrases comprises a natural language generator.

25. The system according to claim 20, wherein the input device comprises a touch tablet display.

26. The system according to claim 20, wherein a previous clinical medical record exists for the patient, and wherein the defined retrievable clinical lexicon is modified via information contained within the previous clinical medical record.

27. The system according to claim 20, further comprising means for accepting selection of patient anatomic information from a displayed anatomic reference chart.

28. The system according to claim 20, further comprising means for accepting selection of a numeric indicator of severity of a patient condition.

29. The system according to claim 20, further comprising means for displaying information about medical conditions of members of a patient's family via a genetic tree.

30. A system that generates an electronic clinical medical record from a given patient encounter, comprising:
means for accepting entry of an identification of an illness for the patient into a data processing system via an input device;
means for displaying an initial defined retrievable clinical lexicon for the illness via the input device, the defined retrievable clinical lexicon comprising words and phrases associated with the illness;
means for accepting entry of an identification of at least one existing medical condition or prior medical treatment for the patient into the data processing system via the input device;
means for displaying a subsequent defined retrievable clinical lexicon for at least one of the existing medical condition or prior medical treatment via the input device;
means for accepting selection of a subset of words and phrases from the displayed initial and subsequent defined retrievable clinical lexicons for the patient encounter; and means for generating a clinical medical record from the selected subset of words and phrases.

31. The system according to claim 30, wherein the means for displaying initial and subsequent defined retrievable clinical lexicons comprises means for simultaneously displaying words and phrases.

32. The system according to claim 30, further comprising means for adding a word or phrase to the defined retrievable clinical lexicon so that the word or phrase may be incorporated into the clinical medical record.

33. The system according to claim 30, further comprising means for deleting a word or phrase from the defined retrievable clinical lexicon after the word or phrase is not selected after a predetermined number of patient encounters in which the defined retrievable clinical lexicon containing the word or phrase is displayed.

34. The system according to claim 30, wherein the means for generating a clinical medical record from the selected subset of words and phrases comprises a natural language generator.

35. The system according to claim 30, wherein the input device comprises a touch tablet display.

36. A system for generating a plurality of searchable electronic clinical medical records from a plurality of patient encounters between different patients and different clinicians, comprising:
means for accepting entry into a data processing system via an input device an identification of an illness for each of a plurality of patients during a respective plurality of patient encounters;
means for displaying a respective defined retrievable clinical lexicon for an illness for each of the plurality of patients via the input device, each respective defined retrievable clinical lexicon comprising words and phrases associated with an illness;
means for accepting selection of a subset of words and phrases from each respective displayed defined retrievable clinical lexicon;
means for generating a respective clinical medical record for each patient from words and phrases selected from a respective displayed defined retrievable clinical lexicon;
means for searching the plurality of separate clinical medical records for at least one word or phrase; and
means for generating a report indicating those separate clinical medical records from among the plurality of separate clinical medical records containing the at least one word or phrase.

37. The system according to claim 36, further comprising means for performing statistical analysis on the plurality of separate clinical medical records.

38. The system according to claim 37, wherein the means for performing statistical analysis comprises means for performing regression analysis or multivariate analysis.

39. A computer program product that generates an electronic clinical medical record from a given patient encounter, the computer program product comprising a computer usable storage medium having computer readable program code embodied in the medium, the computer readable program code comprising:
computer readable program code that accepts entry of an identification of an illness for that patient into a data processing system via an input device;
computer readable program code displays an initial defined retrievable clinical lexicon for the illness via the input device, the defined retrievable clinical lexicon comprising words and phrases associated with the illness;
computer readable program code that accepts selection of a subset of words and phrases from the displayed defined retrievable clinical lexicon for the patient encounter; and
computer readable program code that generates a clinical medical record from the selected subset of words and phrases.

40. The computer program product according to claim 39, wherein the computer readable program code that displays an initial defined retrievable clinical lexicon comprises computer readable program code that simultaneously displays the words and phrases of the defined retrievable clinical lexicon.

41. The computer program product according to claim 39, further comprising computer readable program code that adds a word or phrase to the defined retrievable clinical lexicon so that the word or phrase may be incorporated into the clinical medical record.

42. The computer program product according to claim 39, further comprising computer readable program code that deletes a word or phrase from the defined retrievable clinical lexicon after the word or phrase is not selected after a predetermined number of patient encounters in which the defined retrievable clinical lexicon containing the word or phrase is displayed.

43. The computer program product according to claim 39, wherein the computer readable program code that generates a clinical medical record from the selected subset of words and phrases comprises a natural language generator.

44. The computer program product according to claim 39, wherein the input device comprises a touch tablet display.

45. The computer program product according to claim 39, wherein a previous clinical medical record exists for the patient, and wherein the defined retrievable clinical lexicon is modified via information contained within the previous clinical medical record.

46. The computer program product according to claim 39, further comprising computer readable program code that accepts selection of patient anatomic information from a displayed anatomic reference chart.

47. The computer program product according to claim 39, further comprising computer readable program code that accepts selection of a numeric indicator of severity of a patient condition.

48. The computer program product according to claim 39, further comprising computer readable program code that displays information about medical conditions of members of a patient's family via a genetic tree.

49. A computer program product that generates an electronic clinical medical record from a given patient encounter, the computer program product comprising a computer usable storage medium having computer readable program code embodied in the medium, the computer readable program code comprising:
computer readable program code that accepts entry of an identification of an illness for the patient into a data processing system via an input device;
computer readable program code that displays an initial defined retrievable clinical lexicon for the illness via the input device, the defined retrievable clinical lexicon comprising words and phrases associated with the illness;
computer readable program code that accepts entry of an identification of at least one existing medical condition or prior medical treatment for the patient into the data processing system via the input device;
computer readable program code that displays a subsequent defined retrievable clinical lexicon for at least one of the existing medical condition or prior medical treatment via the input device;
computer readable program code that accepts selection of a subset of words and phrases from the displayed initial and subsequent defined retrievable clinical lexicons for the patient encounter; and
computer readable program code that generates a clinical medical record from the selected subset of words and phrases.

50. The computer program product according to claim 49, wherein the computer readable program code that displays initial and subsequent defined retrievable clinical lexicons comprises computer readable program code that simultaneously displays words and phrases.

51. The computer program product according to claim 49, further comprising computer readable program code that adds a word or phrase to the defined retrievable clinical lexicon so that the word or phrase may be incorporated into the clinical medical record.

52. The computer program product according to claim 49, further comprising computer readable program code that deletes a word or phrase from the defined retrievable clinical lexicon after the word or phrase is not selected after a predetermined number of patient encounters in which the defined retrievable clinical lexicon containing the word or phrase is displayed.

53. The computer program product according to claim 49, wherein the computer readable program code that generates a clinical medical record from the selected subset of words and phrases comprises a natural language generator.

54. The computer program product according to claim 49, wherein the input device comprises a touch tablet display.

55. A computer program product for generating a plurality of searchable electronic clinical medical records from a plurality of patient encounters between different patients and different clinicians, the computer program product comprising a computer usable storage medium having computer readable program code embodied in the medium, the computer readable program code comprising:
computer readable program code that accepts entry into a data processing system via an input device an identification of an illness for each of a plurality of patients during a respective plurality of patient encounters;
computer readable program code that displays a respective defined retrievable clinical lexicon for an illness for each of the plurality of patients via the input device, each respective defined retrievable clinical lexicon comprising words and phrases associated with an illness;
computer readable program code that accepts selection of a subset of words and phrases from each respective displayed defined retrievable clinical lexicon;
computer readable program code that generates a respective clinical medical record for each patient from words and phrases selected from a respective displayed defined retrievable clinical lexicon;
computer readable program code that searches the plurality of separate clinical medical records for at least one word or phrase; and
computer readable program code that generates a report indicating those separate clinical medical records from among the plurality of separate clinical medical records containing the at least one word or phrase.

56. The computer program product according to claim 55, further comprising computer readable program code that performs statistical analysis on the plurality of separate clinical medical records.

57. The computer program product according to claim 55, wherein the computer readable program code that performs statistical analysis comprises computer readable program code that performs regression analysis or multivariate analysis.
